(19) United States
(12) Patent Application Publication
(10) Pub. No.: US 2026/0327499 A1
(43) Pub. Date: Oct. 22, 2026

(54) USE OF A METAL-FREE CARBON MATERIAL FOR CONVERTING PLASTIC INTO C2-C4 OLEFINS AND/OR HYDROCARBONS, UNDER DIRECT INDUCTION HEATING, AND METHOD THEREOF

(71) Applicants: CENTRE NATIONAL DE LA RECHERCHE SCIENTIFIQUE, Paris Cedex 16 (FR); UNIVERSITE DE STRASBOURG, Strasbourg Cedex (FR); SICAT, Strasbourg (FR); BLACKLEAF, Illkirch-Graffenstaden (FR)

(72) Inventors: Cuong DUONG-VIET, Strasbourg (FR); Charlotte PHAM, Illkirch-Graffenstaden (FR); Cuong PHAM-HUU, Strasbourg (FR); Lai TRUONG-PHUOC, Strasbourg (FR); Jean-Mario NHUT, PLOBSHEIM (FR); Housseinou BA, Strasbourg (FR); Yannick LAFUE, Strasbourg (FR); Stéphane WAMBERGUE, Strasbourg (FR)

(73) Assignees: CENTRE NATIONAL DE LA RECHERCHE SCIENTIFIQUE, PARIS Cedex 16 (FR); UNIVERSITE DE STRASBOURG, Strasbourg Cedex (FR); SICAT, Strasbourg (FR); BLACKLEAF, Illkirch-Graffenstaden (FR)

(21) Appl. No.: 19/105,989

(22) PCT Filed: Aug. 25, 2023
(86) PCT No.: PCT/EP2023/073323

§ 371 Date: Feb. 24, 2025

(30) Foreign Application Priority Data
Aug. 25, 2022 (EP) EP22306251.4
Dec. 9, 2022 (EP) EP22306835.4

(51) Int. Cl. C10G 11/02; B01J 21/18; B01J 35/61; C10G 11/10

(52) U.S. Cl. CPC C10G 11/02; B01J 21/18; B01J 35/612; B01J 35/613; B01J 35/615; B01J 35/617; B01J 35/618; C10G 11/10; C10G 2300/1003; C10G 2400/20

(57) ABSTRACT

The present invention refers to the use of a metal-free carbon material for converting plastic into C₂-C₄ olefins and/or other hydrocarbons, under direct induction heating at temperature less than or equal to 800° C.

The present invention also relates to a process for converting plastic into C₂-C₄ olefin and/or other hydrocarbons, comprising a step of reaction under direct induction heating, with a metal-free carbon material as defined in anyone of the claims, at temperature less than or equal to 800° C.

### TECHNICAL FIELD

The present invention refers to the use of a material for converting plastic into C₂-C₄ olefin(s) and/or other hydrocarbons, and to a process for converting plastic into C₂-C₄ olefin(s) and/or other hydrocarbons.

Therefore, the present invention has utility in plastic and chemistry industry field, especially in recycling field.

In the description below, the references into brackets ([ ]) refer to the listing of references situated at the end of the text.

### BACKGROUND OF THE INVENTION

Plastics represent one of the main commodities for daily uses in almost every domain, spanning from industrial packaging to health care and composites for transport and storage. It has been estimated that about 380 million tons of petroleum-based plastics were produced in 2015. The majority of them are used in packaging (mostly as single-use), while the others ended up in construction, automotive, electrical devices, and many others applications. It has also been estimated that this amount is expected to double by 2035, taken into account the annual growth rate. The single-use of plastics (40%) as commodities represents one of the main contribution to CO₂, causing problem for environmental and health as nowadays, about 90% of the waste plastic is dumped or landfilled while only a small amount is recycled. In addition, a large part of waste plastic is ending up in rivers and oceans, posing problems for natural environment.

New legislations and environmental pushes significantly contribute to the increase of waste plastic recycling to produce raw material for new plastics or liquid fuels for transportation and petrochemicals. The plastic-to-fuel (PTF) transformation has received an ever increasing academic but also industrial interest since the last years. Most recently, several announcements have been made by different industrials for new plants settling to convert waste plastics into valuable gaseous/liquids components which contribute to the renewable Interest for such process.

Plastic waste as such is contaminated with other products and thus, preliminary sorting and cleaning are necessary before initiating the recycling process. Nowadays, depending on the quality and purity of the plastic waste, different processes for recycling can be used: (i) reuse (direct from the waste plastic), (ii) reprocessing or mechanical recycling, (iii) depolymerization to the raw monomeric material (not for all types of waste plastic), (iv) conversion of the waste plastic into hydrocarbon feedstock, and finally (v) energy recovery through incineration. The recycling efficiency also depends on the nature of the various additives present in the plastic.

The conversion of plastic to liquid or gaseous hydrocarbons also allows one to recycle solid waste fractions that cannot be reused or recycled through mechanical or depolymerization processes and to avoid landfill or incineration. Waste plastic recycling allows one to reduce in a significant manner the greenhouse gas (GHG) emission compared to incineration. Alongside with the conversion of waste plastic into liquid fuels, other researches also aim to convert such wastes into light olefins, which display high interest for base chemicals, i.e. raw monomers for plastics production. However, the direct conversion of waste plastics into light olefins is not a straightforward process and thus, indirect route is developed through converting waste plastics into intermediate hydrocarbons and further converting such chemicals into light olefins. Onwudili et al. (Onwudili et al., 2019 ([1])) investigated the conversion of polyolefin vapors from a mixture of plastics (HDPE, LDPE, PP, PS and PET) over FCC (Fluid Catalytic Cracking) with Y-zeolite at 500° C. and ZSM-5 zeolite at 600° C. The amount of C₂-C₄ olefins obtained remains relatively low at ca. 21 wt %.

Depolymerization of polyolefins into their monomeric constituents, plastic-to-olefins (PTO) process, requires relatively harsh pyrolysis conditions and results in a complex mixture of hydrocarbons. In general, pyrolysis of polyolefin at temperature ≤500° C. yields a mixture of paraffinic with carbon chain length in the range of C₁₀-C₄₀ while more aromatics are produced at more severe conditions and finally, olefin-rich gas and char were produced at even more severe conditions (≥700° C.) (Lopez et al., 2017 ([2]); Dogu et al., 2021 ([3])). In order to maximize the olefins fraction, the aliphatic compounds produced under mild conditions can be further processed into lower olefins through a steam cracker (FCC) which can produce a yield of 65 wt. % of olefins. The Synova technology is based on the use of hot fluidized sand bath to crack plastic wastes to produce liquid and tar which is further cracked to produce olefin-rich gas. Anellotech and BioBTX have developed pyrolysis using acid zeolites to convert the plastic pyrolysis vapors to lower olefins and waxes. However, catalyst deactivation requires complex reactor design and frequent catalyst regenerations (J.-P. Lange, Managing Plastic Waste-Sorting, Recycling, Disposal, and Product Redesign, ACS Sustain. Chem. Eng., 2021, 9, 15722-15738 https://doi.org/10.1021/acssuschemeng.1c05013 ([4])).

In addition, in order to reduce the GHG emissions of the chemical industry, it is highly desirable to replace the usual way of operating catalytic processes, i.e. a combination of large gas burners and metal catalysts, by a brand new one. The replacement of natural gas burners by electrified heating systems has received a tremendous industrial interest since the last few years. For example, the recent consortium regrouping several petroleum industrials develops new steam crackers operating with electricity (Layritz et al., 2021 ([5])), electrocatalysis (Schiffer et al., 2017 ([6])) or with intermediate heating modes using electricity such as microwave, plasma or induction heating (Jie et al., 2020 ([7]); Zhou et al., 2021 ([8])). It is also desirable to replace traditional supported metal or zeolitic catalysts by metal-free ones with reduced production costs and environmental impacts (spent catalyst recycling or disposal). Last but not least, the ability to use electricity, directly or indirectly, to produce chemicals, also represents a smart way for storing excedental electrical energy from renewable sources, which could help to improve the energy harvesting from solar and wind.

Inductive heating (IH) has been widely developed in the manufacturing of industrial metallic work pieces (bonding, welding, sintering) in several industries. The heat is generated directly inside the targeted material and thus, it significantly reduces the energy lost by conduction or thermal radiation (Wang et al., 2019 ([9])). In such processes, the heat can be directed inside the interest area without over heating the whole large volume of the oven. For catalytic processes, it can thus avoid thermal decomposition of the reactants and products that would form unwanted amorphous carbon or by-products. Recently, IH mode has been reported as an efficient heating mode for operating catalytic processes with significant improved performance (Wang et al., 2019 ([9])). Alongside with the advantages cited above, IH also represents a green heating mean for operating catalytic processes as it can be operated using exceeding renewable energy (RE) sources, instead of using traditional fuel burner for providing heat to the reactor, which contributes to the reduction of CO₂ for the process. The faster heat generation in the system could also reduce energy loss generated during long start-up when using traditional indirect heating mode. The rapid quenching of the exit gaseous effluent, due to the targeted heating of IH, also reduces in a significantly way the cost of the process by suppressing cooling system at the exit of the catalytic section.

The most commonly used catalysts, for either PTF or PTO (plastic-to-olefin) transformation, are based on acidic zeolites, i.e. ZSM5, USY, which are operated through acidic cracking to generate liquid or gaseous hydrocarbons from pyrolysis polymer vapors. A recent study also pointed out the use of acid carbon-based catalysts for converting industrial waste plastics into jet fuel (Y. Zhang, D. Duan, H. Lei, E. Villota, R. Ruan. Jet fuel production from waste plastics via catalytic pyrolysis with activated carbons. Appl. Energy 251, 113337 (2019)).

However, a need exists for an alternative method that is easy to use, highly selective and energy efficient. The present invention fulfills these and other needs.

### DESCRIPTION OF THE INVENTION

The Applicant has surprisingly found that a metal-free carbon material can be used for PTF and PTO processes.

More particularly, the Applicant surprisingly reports on the combination use of metal-free carbon material and direct induction heating at medium temperature, to directly convert plastics (e.g., waste plastics) into light olefins, especially ethylene and propylene, or into other hydrocarbons such as liquid hydrocarbons, especially fuel oil, and/or paraffinic gaseous C₁ to C₅ hydrocarbons.

The metal-free carbon materials used in the invention are particularly advantageous due to their high resistance towards deactivation in the presence of impurities contained in the plastics (e.g., waste plastics), and their low cost of production compared to other materials. Additionally, due to their chemical inertness, these carbon materials can advantageously be regenerated through chemical treatment, in order to remove the deposited impurities.

In addition, metal-free carbon materials are active for being heated up through direct induction heating, which opens new paths for the development of electrification of processes for the recycling of plastics (e.g., waste plastics).

The combination of carbon materials and induction heating presents several advantages as discussed below.

One of these advantages is that the carbon materials can be arranged in a fixed bed configuration, so that the heat is homogeneously generated on the outer surface of the carbon, where the reaction takes place, by eddy currents resulting from the interaction between the metal-free carbon material and the magnetic field. The high thermal conductivity of such carbon materials also contributes to the high heat transfer within the solid bed which, combined with the high heating rate, allows to maintain the bed temperature during the highly endothermic PTF or PTO process. It is very advantageous compared to prior art heating methods, for example microwave (MW) heating. In a fixed bed, the particles are in contact with one another and have high heat absorption next to the MW antenna. Thus, only a small area around the MW antenna is actually heated, which generate local hot spots which negatively impact the selectivity of the process. In order to disperse the heat among the whole reaction section, fluidization is then needed to provide a homogeneous heat distribution. The use of fluidized bed however induces an excess of energy consumption for moving the material and it also generates fines, through catalyst attrition, which could affect the material integrity.

Another advantage is that the invention may be realized as a two-stage process, i.e., plastic pre-cracking (also called vaporization/liquefaction) in a first-stage reactor, while the plastic vapors/liquids or pre-cracked products are swept with an inert gas toward the reaction stage on the solid material heated by IH. Advantageously, the pre-cracking stage produces liquid and/or gaseous products. Such two-stage process facilitates the control of the temperature of both the pre-cracking stage and the reaction stage. As shown by the Applicant, both model and industrial real waste plastics, including intermediate products from plastic recycling processes, may be used in the PTO or PTF process of the invention.

Another advantage is that the pre-cracking step and reaction temperature can be decoupled which allows one to tune the reaction temperature, in order to modulate either liquid or light olefinic products depending to the downstream applications.

Accordingly, in a first aspect, the present invention provides a use of a metal-free carbon material for converting plastic into C₂-C₄ olefins and/or other hydrocarbons, under direct induction heating at temperature less than or equal to 800° C., preferably less or equal to 700° C. and even preferably less or equal to 600° C., or strictly less than 600° C., or less or equal to 550° C., or less or equal to 500° C., for example between 40° and 600° C., or between 45° and 550° C., or between 45° and 500° C.

In a second aspect, the present invention provides a process for converting plastic into C₂-C₄ olefin and/or other hydrocarbons, comprising a reaction step under direct induction heating, with a metal-free carbon material, at temperature less than or equal to 800° C., preferably less or equal to 700° C. and even preferably less or equal to 600° C., or strictly less than 600° C., or less or equal to 550° C., or less or equal to 500° C., for example between 40° and 600° C., or between 45° and 550° C., or between 45° and 500° C. This step may be referred below as to “cracking step”.

“Metal-free carbon material” refers herein to a material which is substantially free of metal, or preferably is totally free of metal. “Substantially free” means that the material may comprise trace impurities, including metals, metal oxides and/or zeolites. For example, the carbon material may comprise less than 3,000 ppm (0.3 wt. %) of metal based on the total weight of the material, less than 2,000 ppm, less than 1,000 ppm, less than 500 ppm, less than 200 ppm, less than 100 ppm, less than 50 ppm, less than 20 ppm, or even less than 1 ppm of metal.

“Metal” refers herein to any element that form metallic structures under ordinary conditions, and are qualified on the periodic table of elements as metals, which includes alkali metals, alkaline earth metals, transition metals, lanthanides, actinides, and post-transition metals.

“Carbon material” refers herein to a material which is mainly constituted by carbon. For example, the material may be constituted by more than 50 wt. % of carbon, at least 80 wt. % of carbon, at least 85 wt. %, at least 90 wt. %, at least 95 wt. %, at least 98 wt. %, at least 99 wt. %, at least 99.5 wt. %, at least 99.9 wt. %, or at least 99.99 wt. % of carbon. As such, the carbon material employed herein may comprise a carbon component and a non-carbon component, as detailed below.

“Carbon” or “carbon component” refers herein to a component comprising graphite, graphene, carbon black, acetylene black, pyrolytic carbon, activated carbon and any combinations thereof. In particular, the carbon part of the carbon material may be selected from the group comprising or consisting of graphite, graphene, carbon black, acetylene black, pyrolytic carbon, activated carbon and any combinations thereof.

The carbon material may also comprise elements which are non-carbon, as long as these do not qualify as “metal” according to the above definition. The carbon material may comprise one or several non-carbon elements or components, for example selected among Na, K, Si, S, N and O. In particular, the carbon material of the present invention may comprise one or several non-carbon elements selected in the group consisting of Na, K, Si, S, N and O, and mixtures thereof.

The inventors herein demonstrate that the use of metal-free carbon materials, in particular carbon materials comprising no additives or promoters, in combination with induction heating, is advantageous for preparing C2-C4 olefins, as metal-free carbon materials present stronger resistance towards deactivation through encapsulation by deposit carbon or coke precursors, as encountered with zeolite-based materials, as well as a better chemical stability in the presence of organic or inorganic impurities present in the processed polymers. Advantageously, the spent carbon-based material can be regenerated through chemical leaching without appreciable activity loss due to their high chemical inertness compared to other catalysts or materials. Advantageously, the metal-free carbon material may play a role in accelerating the conversion process.

As such, the present invention is based on the combined use of a metal-free carbon material with induction heating for preparing C2-C4 olefins from plastics (e.g. waste plastics). In particular, the present invention relates to such combination wherein the temperature of the induction heating is lower than or equal to 800° C. According to one advantageous embodiment, the invention relates to such combination wherein the metal-free carbon material is arranged in a packed-bed. According to one advantageous embodiment, the invention relates to such combination wherein the metal-free carbon material is rolled carbon felt. These embodiments are more precisely detailed below.

In the present application:
the expression “comprised between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

In some embodiments, the metal-free carbon material has a BET surface area of at least 0.10 m²/g, such as for example from 0.10 to 2,000 m²/g, from 0.20 to 1,500 m²/g, from 0.50 to 1,000 m²/g, from 1.0 to 900 m²/g, from 4.0 to 400 m²/g, as determined by ASTM-D-3663 (Standard Test Method for Surface Area of Catalysts and Catalyst Carriers, 2020).

In some other embodiments, the metal-free carbon material has a BET surface area from 0.10 to 30.0 m²/g, from 0.20 to 20.0 m²/g, or from 0.5 to 6.0 m²/g, or from 1.0 to 3.0 m²/g, as determined by ASTM-D-3663 (Standard Test Method for Surface Area of Catalysts and Catalyst Carriers, 2020).

Advantageously, there is no technical limitation for a maximum BET value. A very high BET value means the presence of micropores which have no particular function but which do not interfere with the reaction. In some preferred embodiments, the BET surface area of the metal-free carbon material is as small as possible, for example lower than 30.0 m²/g, lower than 20 m²/g, lower than 6.0 m²/g, 8.0 m²/g or even lower than 6.0 m²/g. The inventors have surprisingly found that the smaller the BET surface area, the less energy is needed to heat the metal-free carbon material. Without wanting to be bound by a particular mechanism of action, it is possible that in such case, a high intrinsic thermal conductivity of the carbon material allows high heat dissipation within it. It may also allow shifting the conversion products towards C₂-C₄ olefin. In the case of PTO process, the results seem to indicate that the external surface area, i.e., exposed geometric surface, is an important factor to convert plastic into light olefins. Advantageously, the metal-free carbon material is a non-porous or low porous material, i.e., characterized by the absence of a network of pores or a minimal pore network, in order to have a small specific area. In this embodiment, the material may have a pore diameter higher than 500 nm, higher than 1 μm, higher than 3 μm or even greater than 5 μm, as measured by ASTM D4284 (Standard Test Method for Determining Pore Volume Distribution of Catalysts and Catalyst Carriers by Mercury Intrusion Porosimetry).

In some embodiments, the carbon material has a geometric structure allowing a good connectivity between its primary particles, and therefore a high intrinsic thermal conductivity of the carbon material allowing the high heat dissipation within its matrix. The geometric surface of the carbon material may be for example greater than or equal to about 1.10-2 m²/g, or greater than or equal to about 1.10-3 m²/g, or preferentially greater than or equal to about 1·10⁻¹ m²/g, and up to 2 m²/g. The geometric surface may be measured by any mean or method known by the skilled person, for example by X-ray computed microtomography (Moncada Quintero et al.: “Investigating mass transfer coefficients in lean methane combustion reaction through the morphological and geometric analysis of structured open cell foam catalysts”, Chemical Engineering Science Volume 281, 5 Nov. 2023, 119138 ([18])).

As detailed above, several forms of carbon can be used in the present invention. In some preferred embodiments, the carbon material is selected from the group comprising or consisting of graphite, graphene, carbon black, acetylene black, pyrolytic carbon, activated carbon and any combinations thereof. Such carbon material can be produced in different size and shape, as explained below.

The term “graphite” as used herein, refers to the crystalline form of the element carbon with its atoms arranged in a hexagonal structure. A graphitic carbon has the characteristics of an ordered three-dimensional graphite crystalline structure consisting of layers of hexagonally arranged carbon atoms stacked parallel to each other as determined by X-ray diffraction. The term graphite herein used includes both natural graphite, i.e. essentially in its geologically occurring natural crystalline form, and synthetic graphite, i.e. synthetically prepared or processed graphite. Examples of natural graphite include so-called amorphous (nanocrystalline) graphite, flake graphite, and vein graphite. Examples of synthetic graphite include pyrolytic graphite, highly oriented pyrolytic graphite (HOPG), synthetic graphite flakes. The term “synthetic graphite” as used herein unless further qualified also intends to include non-expanded graphite.

The term “graphene” as used herein, refers to a polycyclic aromatic molecule with carbon atoms covalently bonded to each other in a same plane. The covalently bonded carbon atoms can form a six-member ring as a repeating unit, and may also include at least one of a five-member ring and a seven-member ring. Multiple graphene layers are referred to in the art as graphite. Thus, graphene may be a single layer, or also may comprise a multiple layers of graphene that are stacked on other layers of graphene. Generally, graphene has a maximum thickness of about 100 nanometers (nm), specifically about 5 nm to about 90 nm, more specifically about 20 nm to about 80 nm. Graphene can be also used in the form of expanded graphite where the graphite structure was partially expanded through incorporation of molecules such as HNO₃, KOH between the layers, to generate a graphite-like structure with high accessibility.

The term “carbon black” as used herein, refers to a form of carbon having a high surface-area-to-volume ratio, albeit lower than that of activated carbon, with a short range ordered structure. Carbon black is a material produced by the incomplete combustion of coal and coal tar, vegetable matter, or petroleum products, including fuel oil, fluid catalytic cracking tar, and ethylene cracking.

The term “acetylene black” as used herein, refers to a carbon black produced by thermal decomposition of acetylene, having a high purity and few factors for inclusion of impurities among many carbon blacks, a high crystallinity and a developed structure.

The term “pyrolytic carbon” refers to any form of carbon obtained by pyrolysis of an organic feedstock or by decomposition of gaseous hydrocarbons at high temperature on a host substrate, be it ceramic or carbon material.

The term “activated carbon” as used herein, refers to a form of carbon having small, low-volume pores that increase the surface area available for adsorption or chemical reactions. It can be produced from various sources such as bamboo, coconut husk, willow peat, wood, coir, lignite, coal, and petroleum pitch that are pyrolyzed and submitted to a subsequent activation treatment aimed at generating micropores. Carbon activation may be operated by any method known by the skilled person.

The carbon material used in the present invention may have different morphologies. The morphology or form of the carbon material is not particularly limited and may for instance include grain, felt, fiber, for example nanofiber, filament, 2D or 3D fabrics, foam as open cell foam, 3D-printed structures, sphere, cloth, monolith, extrudates as honeycombs, rod-shaped, sticks and particles, tube, for example nanotube, ring, trilobes, tablets and nanotablets, and any combinations thereof.

For example, the carbon material may be a commercial graphite felt. The term “graphite felt” (GF) as used herein refers to a textile material that predominantly comprises randomly oriented and intertwined carbon filaments or fibers that has been subjected to a graphitisation process, which may involve heat treating the carbon felt at high temperatures, such as in the range of about 2,600° C. to about 3,300° C. During the graphitising process, the randomly oriented and intertwined carbon filaments or fibers may be converted into an ordered graphite structure. The structuration of the as-synthesized graphite felt was realized through a known process called needle punching. A preferred example of a carbon material for use in the present invention is graphite felt, preferably with the following dimensions: fiber diameter of ca. 10 μm and length up to several millimetres. The fibers present a high degree of entanglement consecutive to the synthesis process and offer a high contact surface to the reactant.

Another example of carbon material is carbon felt. The term “carbon felt” (CF) as used herein refers to a textile material that predominantly comprises randomly oriented and intertwined carbon filaments or fibers. Without limitation, carbon felt suitable for use in the instant invention is commercially available e.g., from Avcarb or Cera Materials. Advantageously, the carbon felt may have a thickness of from about 2 mm to about 20 mm. For example, the carbon felt may have a thickness of from about 4 to about 15 mm, from about 6 to about 10 mm, or from about 2 to about 6 mm. For example, the carbon felt may have a geometric surface area of 0.19 m²/g for fibres of 10 μm diameter, a density of about 2.1 g/cm³ and a BET of 4 m²/g, or of 1.9 m²/g when the carbon contains 90% porosity.

The CF can be also used with different configurations, e.g., as such, planar or in “rolled” configuration, for giving a different surface contact and length depending to the downstream applications. “Rolled CF” refers herein to a carbon felt wrapped around an axis. The rolled CF may have any size; it may have for example a diameter comprised between 20 and 2,000 mm, preferably between 40 to 1,000 mm, and most preferably between 100 to 800 mm and a length comprised between 30 and 3,000 mm, preferably between 100 to 2,000 mm, and most preferably between 300 to 800 mm.

Another example of carbon material is “carbon nanotube” or “CNT” that may refer to a hollow cylindrical or tube shape carbon structure, defining a void therein, which may be empty or filled with another material. CNTs may be closed at one or both ends. CNTs may be conceptualized as rolled graphene sheets, having a hexagonal lattice of carbon molecules with basal planes exposure. Depending on the rolling degree and the way the original graphene sheet is formed, carbon nanotubes of different diameter and internal geometry can be formed. Carbon nanotubes formed by rolling up of a single sheet forming the aforementioned cylinder, are called “single-walled” carbon nanotubes. The carbon nanotubes formed by rolling up more than one sheet of graphene with a structure that resembles a series of concentric cylinders of increasing diameters from the center to the periphery are called “multi-walled” carbon nanotubes. Suitable carbon nanotubes for use in the present invention encompass single-walled carbon nanotubes as well as multi-walled carbon nanotubes. In certain embodiments wherein carbon nanotubes are multi-walled carbon nanotubes, the multi-walled carbon nanotubes comprise 2 or more, such as from 2 to 20, or 5 to 50, graphitic layers. In certain embodiments, carbon nanotubes as used herein have a high aspect ratio, i.e. length-to-diameter ratio, preferably an aspect ratio of between 10 and 10,000,000 to 1, such as between 100 and 10,000 to 1. In certain embodiments, carbon nanotubes as used herein have an average outer diameter of about 2 to 100 nm, such as about 5 to 50 nm, such as about 8 to 30 nm, such as about 20 nm. The average inner diameter of carbon nanotubes as used herein can be about 0.5 to 100 nm, or about 1 nm to 50 nm.

Another example of carbon material is “carbon nanofiber” or “CNF” including a carbon-containing material comprising a solid cylindrical shape, with prismatic planes exposure, mostly free of voids meaning without a hollow central portion, despite some small channel could exist. A carbon nanofiber may be similar to a carbon nanotube (CNT), but may include a solid core rather than a hollow central portion, and prismatic planes, with higher reactivity, exposure instead of basal ones. Carbon nanofibers may be formed through any method known in the art, including deposition from carbon containing vapour, such as by catalytic chemical vapour deposition (CCVD) using different gaseous carbon sources wherein carbon is deposited in the presence of a transition metal catalyst on a macroscopic substrate, or other methods of forming carbon nanofibers known in the art.

Advantageously, carbon nanofibers may have a length of about 100-1000 nm, such as about 150-500 nm. In certain embodiment, carbon nanofibers as used herein may have the aspect ratio, i.e. the ratio of length to the outer diameter, of preferably more than about 10, such as more than about 50, or more than about 100, or more than about 1000, or more than about 2000.

Advantageously, carbon nanofibers as used herein may have a mean average diameter less than 1000 nm. In certain embodiments, the carbon nanofibers have a mean average diameter less than 500 nm, such as less than 300 nm.

It is worthy to note that both CNT and CNF can be grown on macroscopic substrates such as ceramics or oxides, i.e. silicon carbide, silica, alumina, and the combination of them, or also on other host substrates such as activated carbon or even graphite and carbon felt. Such structured composites could allow one to control the flow pattern within the solid bed as well as to increase the surface contact between the reactant and the solid.

Other examples of suitable forms of carbon materials include grains having an average particle diameter of 0.1 to 5 mm, extrudates with an average particle diameter of 1 to 5 mm and lengths up to 2, 3, 4, 5, 6 or more mm, trilobes with an average particle diameter ranged between 1 to 5 mm and length between 1 to 10 mm, foams with ppi (pores per inch) ranged from 60 to 5 ppi, honeycombs with cpsi (cells per square inch) ranged from 5 to 900, tubes with aspect ratios of about 5:1 (meaning 1 mm diameter×5 mm long), 3:1 or 2:1, depending on the diameter of the material.

In some embodiments, the metal-free carbon material is not mixed with the plastic material to be converted. For example, the metal-free carbon material may be arranged as a packed bed (also called sometimes fixed bed), preferably with 3D connected structured materials, in order to favour a good continuity of matter within the whole reaction zone. Therefore, forms as felt, fiber, for example nanofiber, filament, 2D or 3D fabrics, foam as open cell foam, 3D-printed structures, sphere, cloth, monolith, extrudates as honeycombs, rod-shaped, sticks and particles, tube, for example nanotube, ring, trilobes, tablets and nanotablets are preferred. More preferably, the form is felt and most preferably rolled felt with connected structure and with variable length depending to the reaction conditions. Such connected structured materials allow the heat to be rapidly vectorised in the whole matrix of the packed bed and thus, reducing the overall power input from the inductor for a given reaction temperature.

As mentioned above, the carbon material may be a combination of at least two materials as defined above.

In some embodiments, the metal-free carbon material is supported by a structure (also called substrate or support structure) while being used for preparing the reaction products. Such structure may for example be a non-carbon structure, made of alumina, silica, silicon carbide or other oxides or ceramics or the combination of them. Such support structure has the function of physically holding the metal-free carbon material. The support structure is not made of an induction active material, and as such, it does not participate in the conversion reaction. Therefore the support structure, when present, has no heating or catalytic effect. As an example, a graphene coating can form a continuous film on such support structure which confers a high electric connectivity to the carbon material and allow an efficient heating under induction mode. In contrast, the support structure alone cannot be heated by induction heating. The coating layer on the surface of the support structure also allows the generation of heat, provided by the induction heating, exclusively on the material surface where the reaction takes place. The graphene coating can be also applied on activated carbon structure in order to improve the electrical connectivity. Such connectivity significantly improves heat harvesting from the induction coil leading to a temperature increase in the composite. Optionally, such a better connectivity may allow reducing the heating power to be delivered to the carbon material.

“Plastic” should be understood herein in its broadest meaning. In particular, plastic refers herein to any synthetic material made of organic polymers and that can be molded into shape while soft, and then set into a rigid or slightly elastic form. It may be for example at least one selected among high-density polyethylene (HDPE) and low-density polyethylene (LDPE), polypropylene, polystyrene, mixed industrial waste plastic, as low-density polyethylene, PET, PVC and polystyrene containing solid residue, plastics containing solid residue, intermediate products from plastic recycling processes as C₁₅-C₄₅ or C₂₀-C₄₀ waxes, and polymers previously pre-cracked at short contact time at temperatures between 300° C. and 600° C. The fact that the process of the invention may be realized on intermediate products from plastic recycling processes makes it possible to use the process of the invention for recycling tires, crude petroleum, kerosene.

“C₂-C₄ olefins” refers herein to at least one aliphatic alkenes chosen among ethylene, propylene and butylene. Preferably, it may be ethylene and/or propylene. According to the invention, the plastic may be converted into one specific olefin, or into a mixture of olefins. In some cases, the conversion may not be complete, and possible traces of diolefins may occur, such as diolefins made from ethylene, propylene and butylene.

“Other hydrocarbons” refers herein to any hydrocarbons other than C₂-C₄ olefins. It may be for example liquid hydrocarbons having at least 5 carbon atoms (also refers herein as C₅₊), such as C₅-C₁₀, or fuel oil, and/or paraffinic gaseous C₁ to C₄ hydrocarbons. It may refer to a mixture of at least two of these hydrocarbons.

“Direct induction heating” refers herein to a process wherein the carbon material is directly heated by a current, generated on the surface of the carbon material through interaction with an electromagnetic field provided by an inductor. In an embodiment of the invention, the carbon material may be heated by generating an alternating electromagnetic field within a reaction zone containing said carbon material, where the alternating electromagnetic field passes through the reaction zone thereby generating an electric current in said carbon material and heating the carbon material. Advantageously, the high intrinsic thermal conductivity of the carbon material allows a rapid heat transfer from the outer surface to the core of the material. The high intrinsic electrical and thermal conductivity of the carbon or carbon coated materials also allows to maintain the reaction temperature at the set temperature, despite the high endothermicity of the reaction and advantageously avoids the production of long chain liquid hydrocarbons due to the decrease of the temperature inside the bed.

Advantageously, the step of direct induction heating may be carried out at a reaction pressure comprised between 0.5 and 20.0 bar, for example between 1 and 5.0 bar.

The present invention relates to a process for converting plastic into C₂-C₄ olefin(s) and/or other hydrocarbons, comprising a reaction step under direct induction heating, with a metal-free carbon material, at a temperature lower than or equal to 800° C.

The invention also generally relates to a process for preparing C₂-C₄ olefin(s) and/or other hydrocarbons, comprising a reaction step under direct induction heating, with a metal-free carbon material, at a temperature lower than or equal to 800° C.

The reaction step may also be indifferently referred to herein as the “cracking step”, “induction cracking step” or cracking stage”.

The process of the present invention may also be carried out as a two-stage process. Indeed, the process may include a first step (also mentioned therein as “first stage”) consisting in pre-cracking the plastics before the cracking step involving IH. The first step may be carried out in the absence of a metal-free carbon material. Alternatively, it can be carried out in the presence of some materials which can harvest the heat from the oven in order to improve the heat transfer to the plastic, in a first step, while vapors and/or liquids are swept toward the metal-free carbon material in a second step, where a cracking step under direct induction heating takes place. The liquids produced in the first stage can be in a gaseous form at the exit temperature of the stage. Such temperature may notably vary from 200 to 600° C. as it allows to maintain the heavy hydrocarbons in their gaseous form as they are flushed either downward or upward to the induction cracking stage.

The pre-cracking step advantageously allows the production of fragments of polymers with shorter chains, such as C₁₅-C₄₅, or even C₂₀-C₄₀. It may also allow the vaporization of the plastic (e.g, waste plastic) to produce a mixture of liquid and gas. It is noted that the gas fraction can be increased by increasing the sojourn time of the polymer within this first pre-cracking stage. The gas fraction can be also increased by increasing the temperature at the exit of the pre-cracking stage as at high temperature the liquid long-chain hydrocarbons will be converted to gas fraction of the exit mixture thus containing approximately 90 wt. % liquid and 10 wt. % gas, preferably 50 wt. % of liquid and 50 wt. % of gas, and most preferably 20 wt. % of liquid and 80 wt. % of gas.

The first optional step may be carried out by any method commonly used by the skilled person in order to pre-crack the plastic, for example Joule heating, induction heating and/or microwave heating. The pre-cracking step may be carried out in the presence of silicon carbide (SiC), metal beads or any heat conductor materials.

The pre-cracking conditions may be determined by the skilled person, depending on the nature and amount of plastic, the presence of heat conductor materials, or of the kind of heating mode. The temperature of the first step may be comprised between 300° C. and 600° C., between 350° C. and 550° C., between 400° C. and 540° C., between 450° C. and 500° C., advantageously about 500° C. and preferentially about 450° C. For example, if Joule heating is performed, the temperature may be comprised between 450° C. and 600° C. Alternatively, if induction heating is performed, the temperature may be comprised between 450° C. and 500° C. The time of the first step may be comprised between 5 and 100 minutes, preferably between 15 and 60 minutes, for example about 30 minutes. For example, the pre-cracking step may be realized in a first-stage reactor. Then, the plastic vapors/liquids may be swept, for example with an inert gas such as argon, helium or nitrogen, toward the solid material in a second-stage reactor, where the cracking process takes place. The C₂-C₄ olefins and/or other hydrocarbons are then obtained during the cracking step. In another operation mode other gas such as hydrogen or other light hydrocarbons can also be used as sweep gas.

The first step of pre-cracking may be advantageous as it shifts the reaction conversion towards obtaining olefin(s) rather than other hydrocarbons, and therefore allows a greater level of C₂-C₄ olefins than other hydrocarbons, compared to a process without the first step.

In an embodiment, the first step can be replaced by cracking directly polymers with shorter chains, such as C₁₅-C₄₅, or even C₂₀-C₄₀, and/or polymers previously distilled at temperatures between 20° and 500° C. These polymers may be intermediate products from plastic recycling processes.

In one aspect, the invention also relates to a process for preparing C₂-C₄ olefin(s) and/or other hydrocarbons comprising a reaction step under direct induction heating, with a metal-free carbon material, at a temperature lower than or equal to 800° C. In such process, the input material may be a plastic material as described above. For example, the plastic material may be a mixture of C₁₅-C₄₅ olefins, or C₂₀-C₄₀ olefins, also called sometimes waxes. As such, the present invention also relates to a process for converting C₁₅-C₄₅ olefins, or C₂₀-C₄₀ olefins, into C₂-C₄ olefin(s) and/or other hydrocarbons, preferably into C₂-C₄ olefin(s).

The process can be operated in continuous mode and therefore the operating time of the different steps depends on the amount of plastic to be processed. For example, the time of the “cracking step” may be comprised between 2 and 20 minutes, for example about 10 minutes.

Depending on the carbon nature of the cracking step, i.e., non-porous vs porous, the liquid vs gaseous fraction can be tuned by changing the reaction conditions. For example, on non-porous material under certain reaction conditions, as exemplified in the examples, gaseous fraction could be produced as the main fraction, with mostly light olefins as the main product, while on porous material the liquid fraction is higher with respect to the gaseous one, with liquid fraction from C₆ to C₂₅ depending to the reaction temperature.

Advantageously, at the end of the cracking step, the resulting liquid hydrocarbons (also named “liquid fraction”) may be condensed, and/or the gaseous resulting products (also named “gas fraction”) may be directed to gas chromatography for analysis. Advantageously, the gas fraction may comprise at least 5.0 mol. % of unsaturated C₂ to C₄ hydrocarbons, and preferably at least 30.0 mol. % or preferably at least 50.0 mol. % or preferably at least 70.0 mol. % of unsaturated C₂ to C₄ hydrocarbons.

Advantageously, liquid fraction, generated on porous carbon material, can be used as such in different chemical processes, i.e. fuel for transportation, or it could also be recycled onto the carbon material for being cracked down into light olefins, i.e. C₂-C₄ olefins.

In some embodiments, the invention relates to a process for converting plastic into C₂-C₄ olefin and/or other hydrocarbons, comprising:
a step of pre-cracking the plastic, and
a step of reaction under direct induction heating, with a metal-free carbon material, at temperature lower than or equal to 800° C.

In some embodiments, the invention relates to a process for converting plastic into C₂-C₄ olefin and/or other hydrocarbons, comprising:
a step of pre-cracking the plastic, carried out by induction heating, Joule heating or microwave heating, at a temperature comprised between 300° C. and 600° C., and
a step of reaction under direct induction heating, with a metal-free carbon material, at temperature lower than or equal to 800° C.

In some embodiments, the invention relates to a process for converting plastic into C₂-C₄ olefin and/or other hydrocarbons, comprising:
a step of pre-cracking the plastic, carried out on metal beads or any heat conductor materials, mixed with the plastic, and
a step of reaction under direct induction heating, with a metal-free carbon material, at temperature lower than or equal to 800° C.

In some embodiments, the invention relates to a process for converting plastic into C₂-C₄ olefin and/or other hydrocarbons, comprising:
a step of pre-cracking the plastic, and
a step of reaction under direct induction heating, with a metal-free carbon material, at temperature lower than or equal to 800° C.,
wherein during the step of pre-cracking, the plastic is pre-cracked in a first-stage reactor, while vapors and/or liquids (this later in a gaseous form at the temperature between 20° and 400° C.) generated in the first section are swept with a gas flow toward the material in a second-stage reactor where the cracking process takes place.

This invention is further illustrated by the following examples with regard to the annexed drawings that should not be construed as limiting.

### BRIEF DESCRIPTION OF THE FIGURES

FIG. 1: represents Plastic-to-Olefins (PTO) process (selectivity wt. %) on planar Carbon Felt (CF) material as a function of the reaction temperature under direct induction heating for converting model HDPE. (A-B) Gaseous and liquid products distribution (H₂ and Cₙ), (C-D) Gaseous products distribution (H₂ and C₁-C₇). Reaction conditions: HDPE weight=6 g (mixed with 2 g of SiC for improving the heat transfer), CF weight=0.54 g, reactor diameter=26 mm, argon flow rate=15 mL·min⁻¹, HDPE vaporization temperature=450° C., CF temperature=variable.

FIG. 2: represents Plastic-to-Olefins (PTO) process (selectivity wt. %) on planar Carbon Felt (CF) material as a function of the reaction temperature under indirect Joule heating for converting model HDPE. (A, B) Liquid and gaseous products distribution (H₂ and Cₙ including almost solid waxes), (C, D) Gaseous products distribution (H₂ and C₁-C₇). Reaction conditions: HDPE weight=6 g (mixed with 2 g of SiC for improving the heat transfer), CF weight=0.54 g, reactor diameter=26 mm, argon flow rate=15 mL·min⁻¹, HDPE vaporization temperature=450° C. (heating rate of 20° C. min⁻¹), CF temperature=variable.

FIG. 3: represents Plastic-to-Olefins (PTO) process (selectivity wt. %) on rolled CF material for converting model HDPE: (A, C, E) as a function of the reaction temperature and (B, D, F) C₂-C₄ olefins vs saturated fraction for gaseous products ranged from C₁ to C₇ under direct induction heating. Reaction conditions: HDPE weight=6 g (mixed with 2 g of SiC for improving the heat transfer), rolled CF weight=1.2 g, reactor diameter=26 mm, argon flow rate=15 mL·min⁻¹, HDPE vaporization temperature=450° C. (heating rate of 20° C. min⁻¹), CF temperature=variable.

FIG. 4: represents Plastic-to-Olefins (PTO) process (selectivity wt. %) on CF materials, i.e. planar and rolled, operated under IH mode at 550° C. for planar CF and 500° C. for rolled CF for converting model HDPE plastic into light olefins. (A, C) Product distribution. (B, D) Olefins vs gaseous saturated C₂-C₄ fraction. Reaction conditions: HDPE weight=6 g (mixed with 2 g of SiC for improving the heat transfer), CF weight=0.54 g (planer CF) and 1.2 g (rolled CF), reactor diameter=26 mm, argon flow rate=15 mL·min⁻¹, HDPE vaporization temperature=450° C. (heating rate of 20° C. min⁻¹).

FIG. 5 represents Plastic-to-Olefins (PTO) process (selectivity wt. %) using a mixed industrial polymer waste on CF materials, i.e. planar and rolled CF, operated under IH mode at 550° C. for planar CF and 500° C. for rolled CF, for converting industrial mixed waste plastics into light olefins. (A, C) Product distribution and C₂-C₄ fraction on rolled CF material, (B, D) Product distribution and C₂-C₄ fraction on planar CF material. Reaction conditions: mixed industrial plastic weight=6 g (mixed with 2 g of SiC for improving the heat transfer), CF weight=0.54 g (planar CF) and 1.2 g (rolled CF), reactor diameter=26 mm, argon flow rate=15 mL·min⁻¹, HDPE vaporization temperature=450° C. (heating rate of 20° C. min⁻¹).

FIG. 6 represents the cycling tests of the plastic-to-Olefins (PTO) process on rolled CF material (diameter, 26 mm, height, 15 mm) at 450° C. operated under IH mode for converting industrial mixed waste plastics into light olefins. (A-C) Product distribution as a function of the cycling tests. (D-F) Olefins vs saturated C₂-C₄ fraction as a function of the cycling tests (Cycle 1, cycle 3 and cycle 9). Reaction conditions: HDPE weight=6 g (mixed with 2 g of SiC for improving the heat transfer), CF weight=1.2 g (rolled CF), reactor diameter=26 mm, argon flow rate=15 mL·min⁻¹ or 30 mL·min⁻¹, HDPE vaporization temperature=450° C. (heating rate of 20° C. min⁻¹).

FIG. 7 represents (A) Gas and liquid fraction distribution and (B) olefins C₂-C₄ fraction as a function of cycling tests during the PTO process on rolled CF material (diameter, 26 mm, height, 15 mm) at 450° C. operated under IH mode for converting industrial mixed waste plastics into light olefins. Reaction conditions: Mixed waste plastic weight=6 g (mixed with 2 g of SiC for improving the heat transfer) was used for each cycle, CF weight=1.2 g (rolled CF), reactor diameter=26 mm, argon flow rate=30 mL·min⁻¹, vaporization temperature=450° C.

FIG. 8 represents Plastic-to-Fuels (PTF) process (selectivity wt. %) using model HDPE polymer on 3 mm pellets of MESOC+ material under direct induction heating (500° C.) and indirect Joule heating mode (500 and 550° C.). (A, B) Liquid and gaseous products distribution (H₂ and Cₙ) and gaseous products distribution (H₂ and C₁-C₇) under direct induction heating. (C-F) Liquid and gaseous products distribution (H₂ and Cₙ including also solid waxes) and gaseous products distribution (H₂ and C₁-C₇) under indirect Joule heating. Reaction conditions: HDPE weight=6 g (mixed with 2 g of SiC for improving the heat transfer), MESOC+ weight=3 g, reactor diameter=26 mm, argon flow rate=15 mL·min⁻¹, HDPE vaporization temperature=450° C. (heating rate of 20° C. min⁻¹).

FIG. 9 represents Plastic-to-Fuels (PTF) process (selectivity wt. %) on (A, B) 3 mm pellets of MESOC+ and (C, D) 1 mm pellets of MESOC+ material at 500° C. under induction heating. Reaction conditions: HDPE weight=6 g (mixed with 2 g of SiC for improving the heat transfer), MESOC+ weight=3 g, reactor diameter=26 mm, argon flow rate=15 mL·min⁻¹, HDPE vaporization temperature=450° C. (heating rate of 20° C. min⁻¹).

FIG. 10 represents Plastic-to-Fuels (PTF) process (selectivity wt. %) using model HDPE polymer (A, B) and mixed industrial polymers (C, D) on 3 mm pellets of MESOC+ material under direct induction heating. Reaction conditions: HDPE weight=6 g (mixed with 2 g of SiC for improving the heat transfer), MESOC+ weight=3 g, reactor diameter=26 mm, argon flow rate=15 mL·min⁻¹, HDPE vaporization temperature=450° C. (heating rate of 20° C. min⁻¹), MESOC+ temperature=500° C.

FIG. 11 represents Cycling tests for the Plastic-to-Fuels (PTF) process (selectivity wt. %) on 3 mm pellets of MESOC+ material operated under IH mode at 500° C. for converting model HDPE into fuels. (A, C, E) Product distribution as a function of the number of cycles (A-B: cycle 1, C-D: cycle 2 and E-F: cycle 3. (B, D, F) Olefins vs saturated C₂-C₄ fraction as a function of the number of cycles. Reaction conditions: HDPE weight=6 g (mixed with 2 g of SiC for improving the heat transfer), MESOC+ weight=3 g, reactor diameter=26 mm, argon flow rate=15 mL·min⁻¹, HDPE vaporization temperature=450° C. (heating rate of 20° C. min⁻¹).

FIG. 12 represents plastic-to-olefin (PTO) process of HDPE under different conditions. A) represents the results of PTO process on carbon felt (CF) rolled catalyst on a two steps process. B) represents the results of PTO process on carbon felt (CF) rolled catalyst on a one step process. C) represents the results of PTO process on metal catalyst on a one step process. Top graphs represent the yield (wt %) of H₂ and Cₙ (C₅ to C₄₀) (graphs A and B) or of H₂, C₅ and wax (graph C) produced. Bottom graphs represent the yield (wt %) of H₂ and C₁ to C₇) (graphs A, B and C).

### EXAMPLES

### Example 1: Material for Carrying Out the Process of the Invention

A device for carrying out the invention comprises a first section, which is a polymer supplier which can contain a polymer weight from about 5 to 100 g. The reservoir of this polymer supply section was continuously flushed with an argon flow (30 mL·min⁻¹) in order to avoid any air infiltration inside the reservoir. The polymer extrudates were fed to a vaporization stage localized within an electric furnace (Joule heating) kept at 450° C. and continuously flushed with an argon flow with various flow rate ranged from 15 to 60 mL·min⁻¹. The polymer vapors generated at this stage were brought to the reaction section (also named “cracking stage”) operated either under direct contactless induction heating “IH”) or indirect Joule heating (“JH”) at different temperatures. The reaction products were further passed through a trap maintained at 16° C. for condensing the liquid hydrocarbons while the gaseous products were directed to the gas chromatography (GC) for analysis. The reaction products were analyzed on-line by two VARIAN 3800 gas chromatographs. The first one equipped with two detectors (thermal conductivity detector (TCD) connected to an Agilent J&W DB-1 column and a flame ionization detector (FID) connected to an Agilent J&W CarboBOND column) was used to analyze H₂/CH₄ and hydrocarbons up to C₁₂, respectively. The second one equipped with a FID detector connected to a Restek RT alumina BOND column, was employed to separate lighter hydrocarbons such C₂H₂, C₂H₄ and C₂H₆ and other hydrocarbons up to C₇. Calibration curves were used to quantify CH₄, H₂, C₂ fractions, C₆H₆, C₇H₈, C₈H₁₀, and C₁₀H₈. The Dietz factor method was used for the calculation of other hydrocarbons using the areas of FID integration.

The IH experiment was conducted on an EasyHeat® 8310 induction heating setup (10 KW, Ambrell Ltd) equipped with a spiral 6-turn induction coil (L=1.05 m, pure coil resistance=2.066×10⁻³Ω) and external cooling chiller with recirculated water/glycerol (10%) mixture as cooling media. In a typical experiment, one quartz reactor containing the material, similar to that used for the JH, was placed inside the induction heater coils. The real-time temperature control/regulation was ensured by a PID system (Proportional Integral Derivative controller, Eurotherm model 3504) connected to a laser pyrometer (Optris®, power <1 mW, located at ≈30 cm from the material) focused on the middle of material bed and with the capability of working in 150-1000° C. range. The heating/cooling rate allowed for the system is about 300° C. min⁻¹ in the 160-300° C. temperature range. It is worthy to note that the inductor operated at a frequency of 263 kHz, which generated a much lower magnetic field compared to those operated at lower frequency, i.e., <10 kHz. Indeed, magnetic fields from low frequency induction are more penetrating to the surrounding material. However, in order to further reduce the exposure of the worker to the magnetic field, the setup was localized inside a Faraday cage surrounded with metal mesh.

For indirect Joule heating, the material was localized within an electric oven set at the reaction temperature and controlled by a thermocouple inserted inside the ceramic section of the oven.

For the PTO and PTF processes, both model plastics, i.e. high-density polyethylene (HDPE), and mixed industrial plastic, i.e. low- and high-density polyethylene (LDPE) and polystyrene (PS) containing solid residue, were investigated.

Two kinds of carbon materials are used in the present work: (i) low specific surface area, 4 m²/g, non-porous carbon felt (commercialized by MERSEN Com.) constituted by entangled carbon microfilaments with an average diameter of ca. 10 μm and length up to several hundred micrometers and (ii) porous carbon (MESOC+, commercialized by SICAT SARL) produced industrially with a specific surface area of 300 m²/g and constituted with a large mesoporous network. The different characteristics of these carbon-based materials are presented in Tables 1 to 3.

TABLE 1
Characteristics of the different carbon
materials used in the process.

| | Specific | | |
|---|---|---|---|
| | surface area | | |
| Material | (m²/g) | Producer | Appearance |
| Carbon felt | 4 | MERSEN Com. | Purchased in a |
| | | | form of carpet |
| | | | macroscopic shape |
| | | | with dimension of |
| | | | 1.5 m (width) and |
| | | | 2.0 m (length) with |
| | | | a thickness of 12 mm |
| MESOC+ | 297 | SICAT | Extrudates shape |
| | | SARL | with diameters of |
| | | | either 1 mm or 3 mm, |
| | | | 2 to 4 mm in length |

The detailed characteristics of the carbon felt according to the purchaser are summarized in Table 2.

TABLE 2
Properties of pristine carbon felt (information
provided by the supplier).

| Property | Value | |
|---|---|---|
| Density at 20 °C | 0.08 | g/mL |
| Carbon content | 99.5% | |
| Ash | 500 | ppm |
| Specific Heat | 0.71 | J/g/°C |
| Mean Specific Heat | 1.67 | J/g/°C |
| Emissivity | 0.99 | |
| Sublimation Temperature | 3600 | |
| Surface Area (Nitrogen) | 4 ± 3 | m²/g |
| Thermal Conductivity | — | |
| Approx. Processing Temperature | 2500 | °C |

The detailed characteristics of the MESOC+ according to the purchaser are summarized in Table 3.

TABLE 3
Typical properties of fresh MESOC+ (information
provided by the supplier for 3 mm pellets).

| Property | Value | |
|---|---|---|
| Crushing strength (ASTM D4179) | 40 | N/mm |
| Attrition (ASTM D4058) | <1% | |
| Tapped bed density | 580 | g/L |
| BET surface area | 300 | m²/g |
| Pore volume for pore diameters | 0.48 | mL/g |

between 6 and 100 nm (Hg intrusion)

### Example 2: Polymer Cracking Process

### PTO on Non-Porous Carbon Felt Material

The carbon felt (CF) purchased from Mersen Co. was used without any pretreatment. The CF is constituted by entangled microfilaments with an average diameter of ca. 10 μm and length up to several hundred micrometers. The CF microfilaments are very smooth and contain almost no internal porosity and roughness, which is in good agreement with their low specific surface area. The material also displays a high open voidage up to about 90 vol. %.

For being used as metal-free material, the CF can be directly cut into planar disk, noted planar CF, or in sheet shape, which can be further rolled up to produce a cylindrical shape, noted rolled CF. The rolled CF material seems to be a very good configuration for being used as carbon material for the plastic conversion process as its length can be easily tuned, which allows one to adapt the bed height to control the contact time and exposure surface with respect to the plastic vapors/liquids which improves the light olefins yield. Indeed, such control of bed height is very efficient in the case of rolled CF configuration, because arranging rolled CF pieces in the reactor results in a homogeneous heating of the solid bed. Indeed, the tight contact between the rolled CF pieces does not induce local overheating, which would otherwise result to an inhomogeneous temperature distribution within the solid bed and excessive decomposition of the intermediate compounds into carbon.

### PTO Process on Model HDPE Plastic Waste

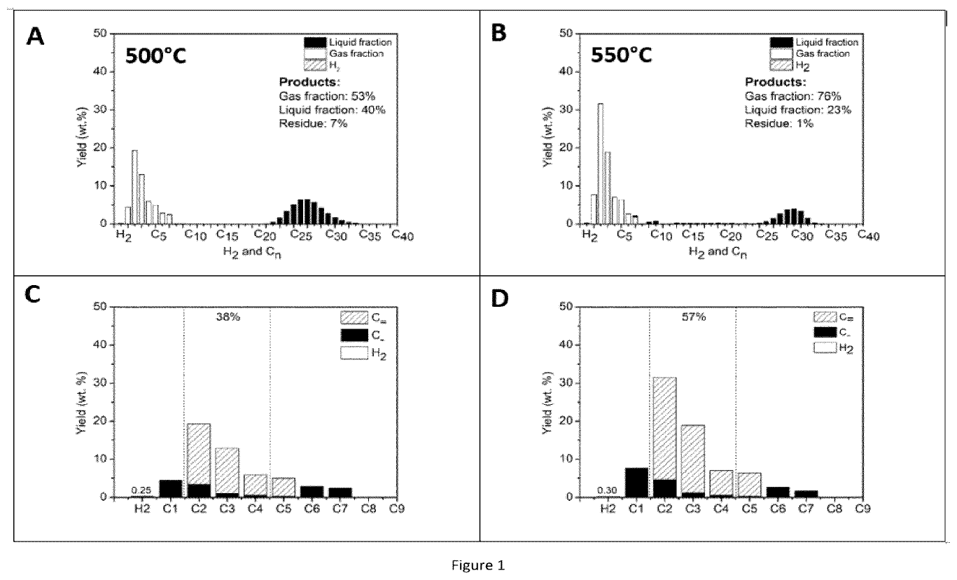

In this example, the conversion of model waste plastic (HDPE) into light olefins is carried out on CF material under both direct induction heating (inventive) and indirect radiative Joule heating (comparative). The results obtained, as a function of the reaction temperature, are presented in FIGS. 1 to 4.

The cracking performance on the planar CF material operated under IH mode increases from 500° C. to 550° C., i.e. gas fraction increases from 53% to 76% (FIG. 1A-B). Liquid fraction is mostly composed of long-chain hydrocarbons ranged between C₁₉ to C₃₀ with a small fraction of C₃₀ to C₃₅ as show in FIG. 1A-B. The small fraction of long-chain hydrocarbons could be attributed to the high void fraction of the CF material, i.e. 90% of empty volume, which could favor some by-pass of the polymer vapors during the test. Blank test carried out under Joule heating with quartz wool instead of CF only yields long-chain hydrocarbons (C>30) which cannot be dissolved in any solvent and no trace of hydrocarbons with carbon chain smaller than 30 can be observed.

The C₂-C₄ olefins vs saturated gaseous fraction obtained as a function of the reaction temperature on the planar CF material under IH also shows the same trend with a C₂-C₄ olefins yield of 33% at 500° C. and 51% at 550° C. (FIG. 1C-D).

It is worthy to note that the color of the as-produced liquid hydrocarbons also changes as a function of the reaction temperature, i.e. darker as increasing the reaction temperature. Such color change could be attributed to the presence of polyolefins or aromatics in the product. It is expected that such products could be favored at high reaction temperature.

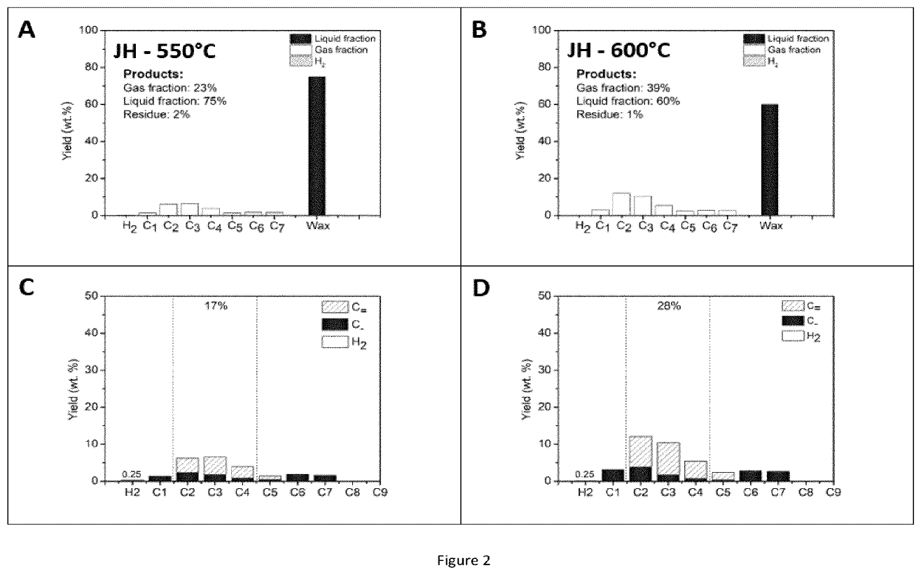

The PTO process as a function of the reaction temperature was also carried out on the CF material operated under indirect Joule heating (comparative) and the results are presented in FIGS. 2A-D. At 500° C., only waxes are obtained on the CF material and the results are not reported as such waxes can hardly be dissolved in a solvent for GC analysis. The products distribution is radically different under JH mode as at reaction temperature of 550° C. and 600° C., gas fraction constitutes only to 23 and 39 wt. %, respectively (FIGS. 2A and B). Inside the gas fraction C₂-C₄ olefins are predominant. Their absolute wt. % is 12 and 22 wt. % based on the initial weight of the waste plastic, respectively at 550° C. and 600° C. The liquid fraction recovered at the reactor outlet is mostly constituted by waxes which cannot be dissolved as shown in the digital photos presented in inset of FIGS. 2A and B.

Such results clearly confirm the high efficiency of the direct IH mode to operate carbon material for the PTO process at low reaction temperature. The high PTO efficiency observed on the CF material under IH could be attributed to several facts: (i) high temperature maintaining efficiency due to the high heating rate of the IH, i.e. several hundred degrees per minute for temperature adjustment, in order to maintain the material temperature for the endothermic cracking reaction; and, (ii) better temperature homogeneity within the entire solid bed as the heat is generated directly within the material body and not through convection/conduction indirect transfer as encountered with the indirect Joule heating mode. Indeed, carbon felt is well known as insulator shield material to prevent heat transfer for high temperature oven, and thus, the carbon filaments display high heat transfer along its filamentous structure but not between the filaments due to the presence of large voidage in the material. In the case of IH, the entire solid volume can be heated while in the case of JH the heat is transferred along the external filaments to the core of the solid bed which is more affected by the filamentous structure of the material. Such heat resistance can be avoided with IH as heat is directly generated through the material body as discussed above and the heat distribution throughout the carbon microfilament is much faster due to the small diameter of the microfilaments which remains within the range of depth penetration for the eddy currents, i.e. few micrometers from the outer surface. The high aspect ratio (length vs diameter) of the carbon microfilaments constituting the CF material also contributes to rapid heat conduction along the filaments and through the entire material matrix and thus, greatly improves the reaction process. By comparing the results between FIGS. 1 and 2, one can definitively prove the advantages of operating the PTO process with a direct and contactless induction heating mode.

### Influence of the CF Macroscopic Shape

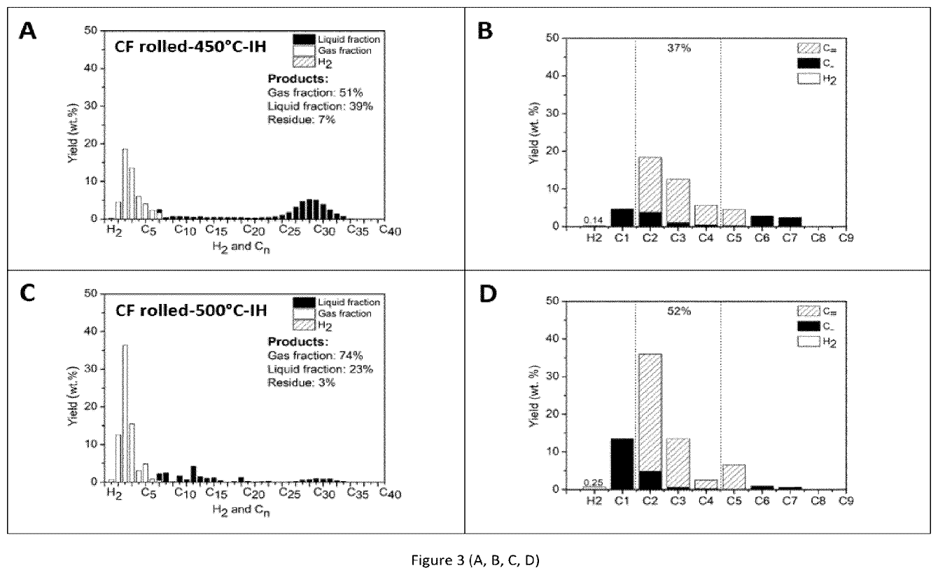

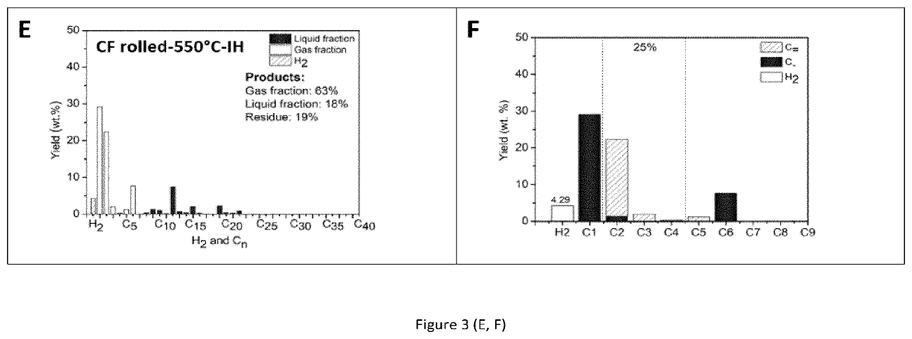

In this data set, a rolled CF material was used instead of planar one and the results are presented in FIG. 3 as a function of the reaction temperature. At reaction temperature of 500° C., the main fraction of the starting plastic is converted into light hydrocarbons (FIGS. 3C and 3D), which is not the case for lower reaction temperature, i.e. 450° C. (FIGS. 3A and 3B), where some liquid fraction is observed. At 500° C., the C₂-C₄ olefins fraction contributes for 46% of the total hydrocarbon products (FIG. 3D), this fraction being mainly composed of ethylene and propylene, while methane contributes to ca. 13 wt. %. Increasing the reaction temperature from 500° C. to 550° C. leads to a sharp increase of the cracking products with a significant contribution of methane, i.e. 29 wt. % (FIG. 3F) along with a significant decrease of light olefins. Ethylene remains the main light olefin with a contribution of ca. 22 wt. % (FIG. 3F). The results obtained indicate that the rolled CF displays higher cracking performances compared to its planar counterpart (with the same apparent volume) at the same reaction temperature. Such results could be attributed to the orientation of the CF within the induction coil, i.e. circular rolling, which could favor the circulation of the eddy currents from the induction heater within the piece of CF leading to a higher heat harvesting and temperature homogenization within the solid bed.

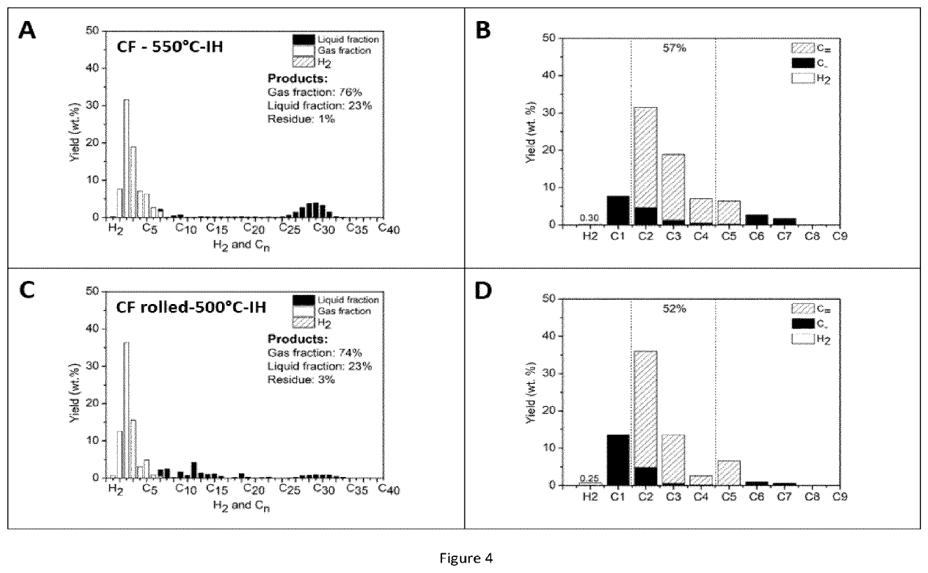

The PTO results obtained on the planar and rolled CF materials are compared in FIG. 4. According to the results, the CF rolled displays higher PTO performances compared to the planar one as the same cracking and production of C₂-C₄ olefins are obtained on the rolled CF material at lower reaction temperature than the one on the planar CF one, i.e. 500° C. vs 550° C. (FIGS. 4B and D). The amount of higher hydrocarbons, i.e. >C₂₅, is also significantly lower on the rolled CF material, which confirms the high efficiency of the rolled CF material to crack down the long-chain polymers passing through it even at lower temperature (FIGS. 4A and C). Such results could be attributed to the difference in terms of carbon microfilaments density between the two structures. Indeed, in the case of CF, produced by a needle punching process, one should have expected to have higher by-pass channels in the planar structure material compared to the rolled one where side face was exposed. The circular orientation of the rolled CF material also favors the induction current which improves the axial heat transfer.

### PTO Process on Industrial Plastic Waste

In this example, the PTO process was investigated on CF materials, i.e. planar and rolled, using a mixture of plastic wastes from different industrial sources (Table 4). The waste plastic was heat treated at 250° C. under argon, in order to melt down the polymers and to measure the exact amount of inorganic solid in the sample.

TABLE 4
Composition of the mixed industrial polymer waste and the origin
of the waste. The PE contributes to >50 wt. % and PS <20
wt. % while the other components are non-plastic solid wastes.

| | | Preliminary | | Weight |
|---|---|---|---|---|
| Product names | Description | use | Appearance | (%) |
| LD Polyethylene | Plastic film | Agriculture | White/Clear/ | >50 |
| | | pallet wrap | Colored film | |
| LLD Polyethylene | Colored plastic film | Industrial film | Green/Black/ | |
| | | wrap | White film | |
| HD Polyethylene | Plastic bottles - drums | Soft drink, milk, | White/Clear/ | |
| | | containers | Colored materials | |
| Polystyrene | Packaging material | Agriculture boxes, | White/Colored | <20 |
| | | electronic | material | |
| | | packaging | | |
| Non-plastic | | Industries | Brown dark | <30 |
| solid waste | | | particles | |

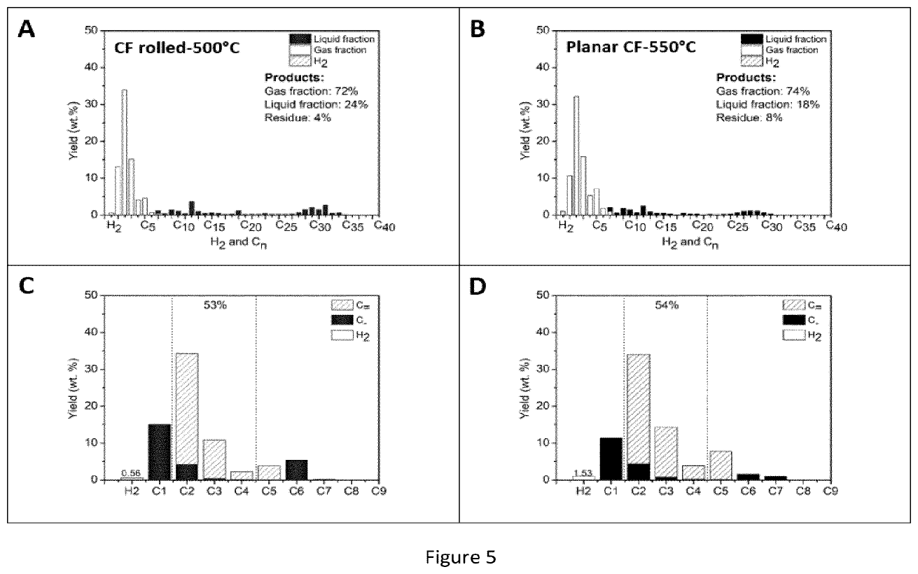

The results show that the CF material, regardless the shape and configuration, operated under IH mode displays high cracking performance to convert mixed industrial polymers into liquid and gaseous hydrocarbons (FIGS. 5A and B). Both materials also display high selectivity towards C₂-C₄ olefins at reaction temperature as low as 500° C. (FIGS. 5C and D). The C₂-C₄ olefins fraction amounted to about 43% on the rolled CF material at 500° C., while it was about 49% on the planar CF material at 550° C. In both cases, ethylene and propylene are the major products of this C₂-C₄ olefins fraction. The very similar results obtained on both CF materials when operating the PTO process with industrial mixed polymer could be attributed to the lower density of this later compared to that of the model polymer, i.e. mixture of LDHP and HDPE instead of pure HDPE, which is easy to be cracked.

The results obtained in the different tests, including model HDPE and mixed industrial waste plastic, are summarized in Table 5 and compared with those reported in the literature.

TABLE 5

| | | | | ΣC₂-C₄ | |
|---|---|---|---|---|---|
| | | | T | olefins | |
| Material | Feed | Reactor | (°C) | (wt. %) | Ref. |
| Planar CF | HDPE | Fixed bed/IH | 500 | 33 | This work (FIG. 1) |
| | HDPE | Fixed bed/IH | 550 | 51 | This work (FIG. 1) |
| Planar CF | HDPE | Fixed bed/JH | 550 | 12 | This work (FIG. 2) |
| Planar CF | HDPE | Fixed bed/JH | 600 | 22 | This work (FIG. 2) |
| Planar CF | LDPE (>50 wt. %), | Fixed bed/IH | 550 | 48 | This work (FIG. 5) |
| | PS (<20 wt. %), | | | | |
| | solid residue | | | | |
| | (20 wt. %) | | | | |
| Rolled CF | HDPE | Fixed bed/IH | 450 | 31 | This work (FIG. 3) |
| | HDPE | Fixed bed/IH | 500 | 46 | This work (FIG. 3) |
| | HDPE | Fixed bed/IH | 550 | 23 | This work (FIG. 3) |
| Rolled CF | LDPE (>50 wt. %), | Fixed bed/IH | 500 | 43 | This work (FIG. 5) |
| | PS (<20 wt. %), | | | | |
| | solid residue | | | | |
| | (20 wt. %) | | | | |
| Fresh FCC | HDPE | Fluid bed | 450 | 22 | Ali et al., |
| | | | | | 2002 ([12]) |
| E-Cat | LDPE in toluene | Riser simulator | 500 | 24 | De La Puente |
| | | | | | et al., 2002 |
| | | | | | ([13]) |
| E-Cat | Mixed polymers | Fluid bed | 460 | 24 | Lin et al., |
| | | | | | 2007 ([14]) |
| Steamed | HDPE | Spouted bed | 475 | 7 | Olazar et al., |
| FCC | | | | | 2009 ([145) |
| E-Cat + | HDPE | Spouted bed | 500 | 23 | Elordi et al., |
| 50 wt. % | | | | | 2012 ([16]) |
| of bentonine | | | | | |
| E-Cat | LDPE | Micropyrolyzer | 600 | 45 | Eschenbacher et |
| | | | | | al., 2022 ([16]) |

### Stability as a Function of Cycling Tests

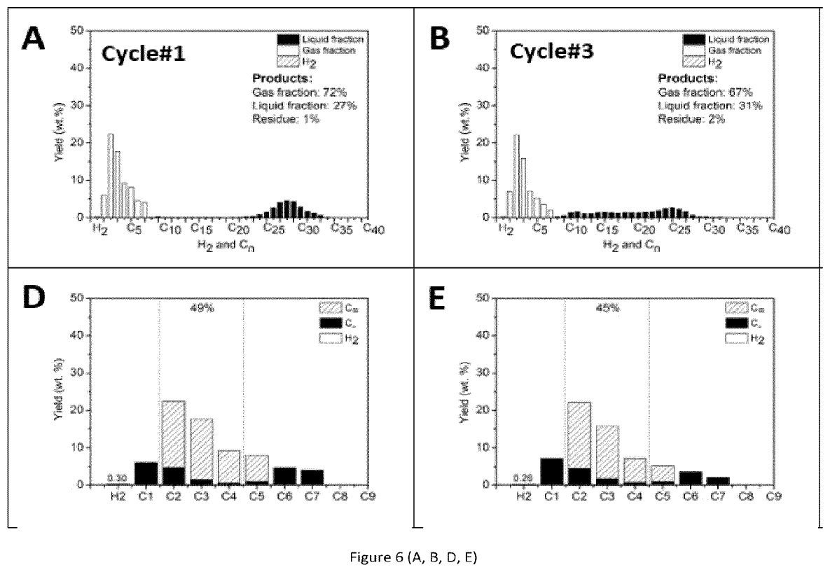

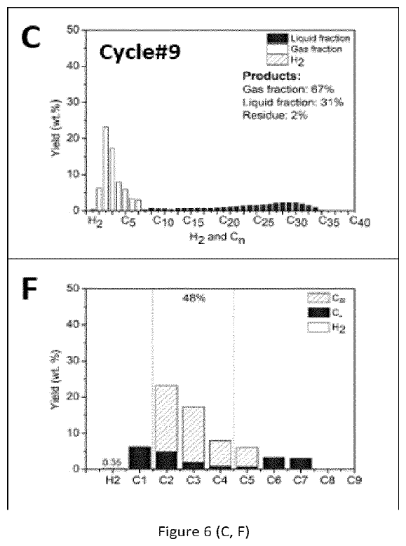

The stability of the CF materials for converting a mixed industrial waste into light olefins was investigated and the results are presented in FIG. 6. The cycling tests are carried out at 450° C. on the rolled CF material, as according to our previous results, this temperature is the most appropriate for performing the PTO process on such material.

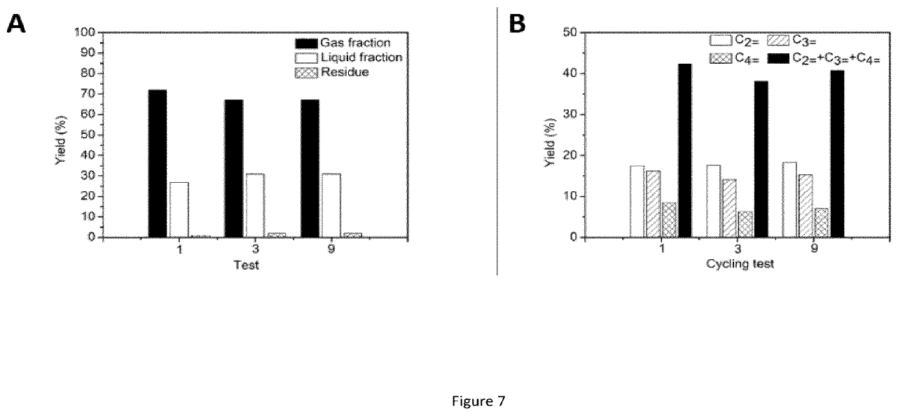

According to the results, the rolled CF material displays a high and stable PTO activity as a function of cycling tests using mixed industrial polymers. Such high stability could be attributed to the following facts: the process was carried out in two-stage, in which the waste polymer was vaporized first in an upper thermal bed, followed by cracking of the polymer vapors in a second reactor containing CF material. The polymer vapors passed through a quartz wool plug, which plays the role of scavenger or filter to block the impurities from the polymer waste and to prevent excessive carbon material deactivation. By operating in such separate sections, the main impurities contained in the raw waste plastics remain in the first thermal bed while much lower impurities, mostly in the gaseous form, passed over the reaction bed which could contribute to its stability as a function of cycling tests. In addition, a layer of 1 mm MESOC+ extrudates (2 mm in length) is added on the top of the rolled CF material, slightly out of the induction coil with a temperature of ca. 450° C., in order to play the role of a scavenger layer and also to better vaporize the adsorbed polymer vapors. It is worthy to mention that at this temperature, i.e. 450° C., the MESOC+ sample displays a very low activity without any ability to produce light olefins. The gas, liquid and solid residue fraction obtained after each cycle at 450° C. is presented in FIG. 7 and confirms the high stability of the rolled CF material for the PTO process.

The weight of deposited solid residue as a function of the cycling tests is also measured. According to the results, the carbon material weight slightly increases, by ca 0.6±0.3 wt. % after each cycle, for the first five cycling tests at 500° C.

### PTF on Porous Carbon Materials

The porous carbon, noted MESOC+, is produced at industrial scale by Sicat SARL (www.sicatcatalyst.com) in the form of extrudates with different macroscopic shapes. For the PTF process, the MESOC+ extrudates with either 1 or 3 mm in diameter and 2 to 4 mm in length were used. Low resolution SEM micrograph carried out on the MESOC+ evidences the roughness of its surface taken under different angles. Medium resolution SEM micrographs evidence the presence of macropores within the material and a highly mesoporous structure which could favor the adsorption and cracking of the pyrolysis polymer vapors.

### PTF Process on Model HDPE Plastic Waste

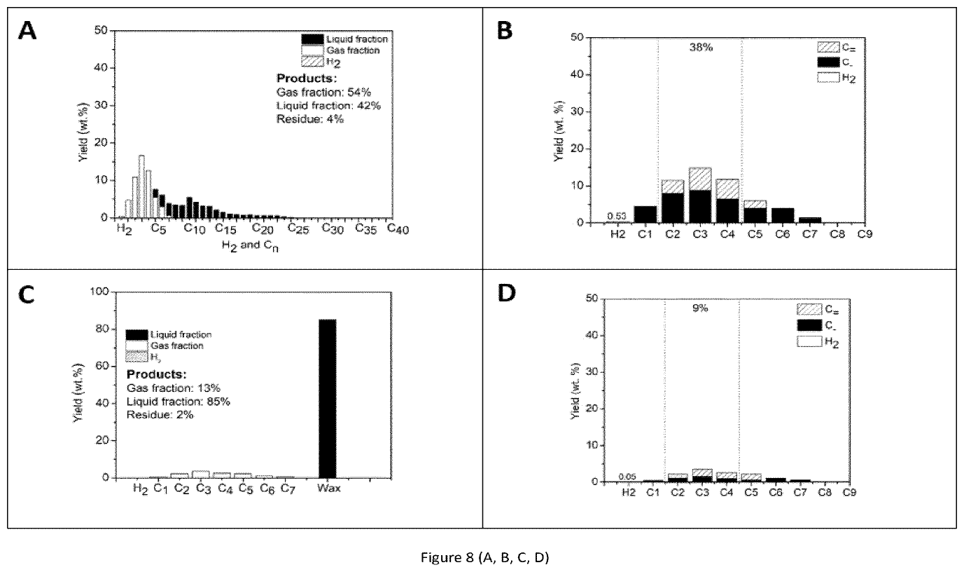

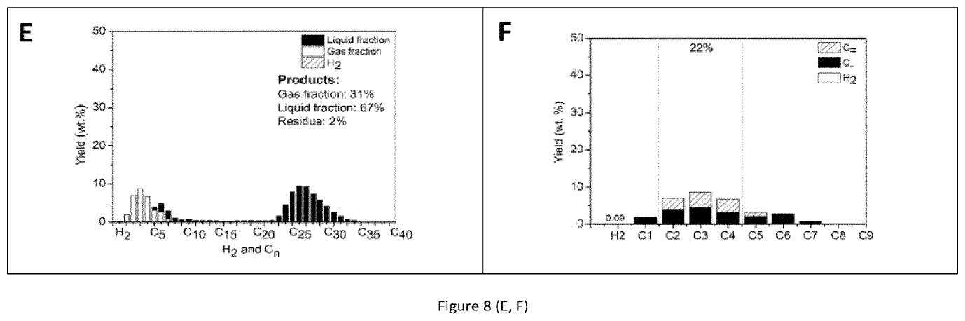

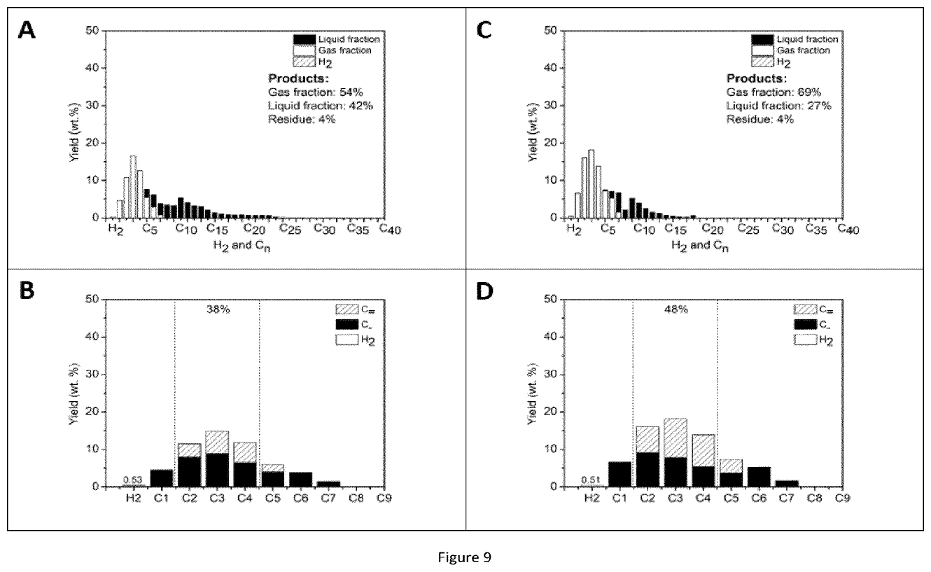

In this section, the conversion of model waste plastic (HDPE) into HC is carried out on MESOC+ material under both direct induction heating (inventive) and indirect radiative Joule heating (comparative). The results obtained are presented in FIG. 8. The 3 mm MESOC+ displays a lower cracking activity than the CF materials, i.e. planar or rolled, at the same reaction temperature of 500° C. However, it is worthy to note that the performances obtained on the 3 mm MESOC under IH remains much higher than under JH mode even at higher temperature (FIGS. 8A vs 8C and E). Such results could be again explained by a higher heat maintaining within the carbon bed. Polymer long-chain cracking is an endothermic process and thus, the efficiency of the solid material is strongly influenced by the effective temperature distribution within the bed and on the carbon surface where the reaction takes place. At high cracking rate the material temperature could be lowered and may thus reduce the cracking performance which is at the origin of the formation of long-chain hydrocarbons or waxes. The low heat supply using indirect heating mode cannot allow one to maintain the optimal bed temperature unlikely to induction heating as the heat is generated directly within the material body. However, it is worthy to note that the 3 mm MESOC+ material mostly yields saturated fraction and also liquid hydrocarbons in the range of C₆ to C₂₀ (FIG. 9A). Such results are different than those obtained on the non-porous CF material operated under similar reaction conditions where light olefins (C₂₌-C₄₌) were predominant. Such results could be explained by the following facts: (i) unlike the non-porous CF the porous nature of the MESOC+ could favor diffusion of the pristine light olefins inside the material porosity and thus, favoring the formation of long-chain olefins or aromatics through recombination of light olefins, (ii) the 3 mm MESOC+ also displays a higher diffusion length compared to the CF one, i.e. 3 mm in diameter vs 10 μm, which could induce internal temperature gradient inside the extrudates with lower cracking performance. Such hypothesis was investigated by changing the 3 mm MESOC (diameter of 3 mm) by a 1 mm MESOC+ (diameter of 1 mm). The comparative results are presented in FIG. 9. According to the results the smaller carbon material, i.e. 1 mm MESOC+, displays improved selectivity in light olefins, despite some liquid hydrocarbons in the range of C₆ to C₁₅ are still observed. On the 3 mm MESOC+ the long-chain hydrocarbons are up to >C₂₃, while on the 1 mm MESOC+ only hydrocarbons containing up to C₁₅ are observed. Such results could be explained by the fact that for the 3 mm MESOC+ material the heat is transferred from the external surface to the inner part of the pellets, as induction heating of electrical conductive materials mostly starts on the outer surface (skin effect) and the temperature is then transferred inside the material body through conduction. Consequently, the solid temperature is expected to be more homogeneous for 1 mm pellets than for 3 mm pellets, resulting in an increased cracking activity of the polymer vapors. The small diameter of the 1 mm MESOC also improves the geometric contact surface between the polymer vapors and the hot material external surface which increases the cracking performance. However, it is worthy to note that the MESOC+ materials still display lower C₂-C₄ olefins yield compared to the CF ones. Such results could be explained by the porosity present in the MESOC+ materials which could favor secondary reaction, i.e. aromatization, whereas the lack of porosity in the CF material prevents such secondary reaction. However, it is worthy to mention that liquid hydrocarbons produced from the pyrolysis of waste plastics could represent also an interesting option as such products could be converted into different fuel fractions, i.e. gasoline, diesel and jet fuel, with low sulfur content.

### PTF Process on Industrial Plastic Waste

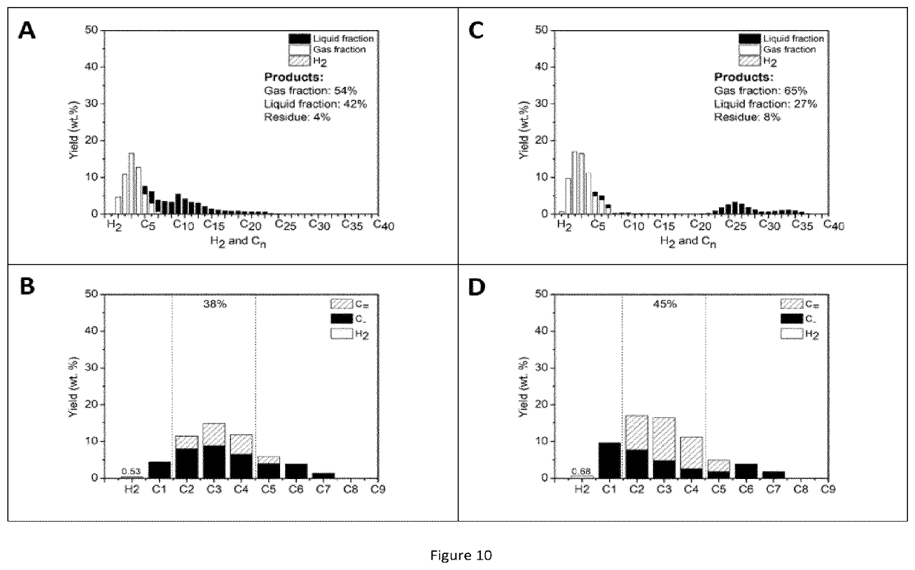

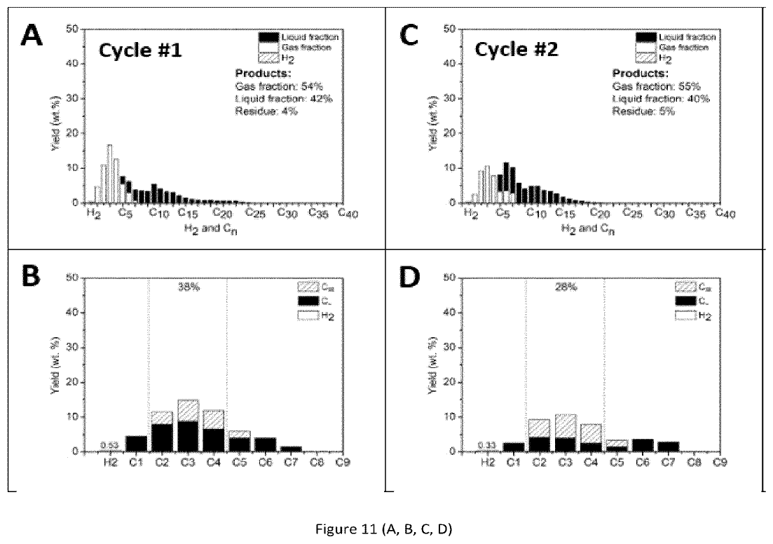

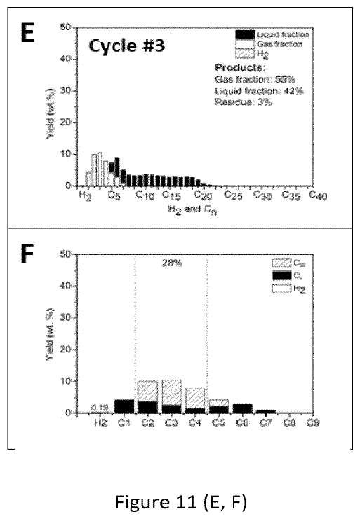

Plastic cracking was also investigated on a MESOC+ material using a mixed plastic waste from different industrial sources (Table 4). The results (FIG. 10) show that the 3 mm MESOC+ material operated under IH mode displays high cracking performance and also high selectivity towards light olefins formation at relatively low reaction temperature from the industrial mixed plastic wastes (FIGS. 11C and D). The formation of small fraction of long-chain liquid fraction could be attributed to the low vaporization temperature of the mixed polymers that contain LDPE, which could provide a larger amount of polymer vapors at the same pyrolysis temperature compared to that of the model HDPE.

### Stability as a Function of Cycling Tests

The stability of the 3 mm MESOC+ material for converting a model HDPE into light olefins and fuel was investigated and the results are presented in FIG. 11. The 3 mm MESOC+ displays an intermediate behavior with a gas fraction of ca. 55% and a liquid fraction amounted to about 42% for all the cycling tests. However, one can notice that for the Cycle #3 a slight increase of the long-chain hydrocarbons, i.e. >C₁₇, can be observed which could be attributed to a partial plugging or encapsulation of some active sites at the origin of the cracking process (FIG. 11E). According to the results, the 3 mm MESOC+ material is able to convert waste plastic into liquid and gaseous hydrocarbons for downstream applications such as polymer processing (ethylene and propylene fraction) or liquid feedstock for transportation or petrochemical processing. The C₂-C₄ fraction decreases from Cycle #1 to Cycle #2, from 38% to 28%, and remains unchanged at Cycle #3, while C₂-C₄ olefins fraction increases from 15% to 17% and 20% for cycle 1, cycle 2 and cycle 3. The results obtained again confirm the ability of the MESOC+ material for converting waste plastics into hydrocarbons which could be used in numerous petrochemical processes.

### Conclusion

In summary we have reported the efficient combined use of metal-free carbon materials and direct induction heating for converting plastics (e.g., waste plastics), either model or industrial mixed, into C₂-C₄ light olefins fraction, especially on non-porous CF material, and liquid hydrocarbons, especially on porous MESOC+ materials. The results have shown that carbon material, either non-porous such as carbon felt or porous ones, are efficient for performing such direct conversion at relatively low temperature under induction heating mode. The carbon materials also display a high stability as a function of cycling tests which again confirms their interest for such process. In this conversion process, the carbon materials are directly heated by the eddy currents, generated on the surface of the material through interaction with the electromagnetic field provided by the inductor. The high intrinsic thermal conductivity of the carbon-based materials significantly improves the heat transfer from the outer surface to the core of the material. It is expected that the heat transfer is more efficient in the case of carbon felt due to the relatively small diameter of the carbon microfilamentous, i.e. 10 μm, which remains within the range of depth penetration for the eddy currents, compared to the mesoporous ones with larger diameter, >1 mm. Such high heat transfers in the carbon felt could be advanced to explain the higher light olefins production from the plastic waste compared to that observed on the larger size mesoporous carbon where temperature gradient within the pellets could hinder the cracking reaction leading to the formation of higher amount of liquid fraction under the same reaction conditions. The difference in terms of light olefins yield between the CF and MESOC+ materials could also be due to diffusion phenomenon between the two materials due to their pore and geometric structure. Induction heating also provides an elegant way to heat up directly the material without excessive energy lost through convection and conduction as usually observed in the case of indirect Joule heating. The results also suggest that carbon materials with smaller dimension, i.e. carbon nanotubes or nanofibers decorated macroscopic host substrates, could be also efficiently heated up using induction heating for performing the PTO or PTF processes.

The non-porous carbon felt, CF, displays a high selectivity towards C₂-C₄ olefins fraction with essentially ethylene and propylene fraction, at reaction temperature ranged between 450 to 550° C. for both model waste plastic (HDPE) and mixed industrial waste plastic containing impurities. The C₂-C₄ olefins can be finely tuned by modifying the operation parameters such as temperature or contact time. The material also displays a high stability as a function of cycling tests with industrial mixed waste plastic which highlight the advantages of using such metal-free carbon materials. Alongside with the C₂-C₄ olefins fraction, other liquid hydrocarbons are also produced from the waste plastic which can be further used in other downstream applications or be recycled on top of the reactor to yield light olefins fraction.

The MESOC+ porous carbon materials display lower light olefins yield and a higher fraction of liquid hydrocarbons ranged from C₅ to C₂₀ contributing to about 50%. The mesoporous carbon materials also display a high stability as a function of cycling tests which also confirms their interest for such process.

It is worthy to note that on both non-porous and porous carbon materials the production of aromatic compounds is extremely low, at reaction temperature ≤500° C., compared to the linear or branched hydrocarbons which could be due to the lack of strong acidity on such carbon materials unlikely to those existing on zeolite catalysts. Such results are of high interest as aromatics formation contributes to an enhancement of a hydrogen pool which can react with unstable intermediate olefins to yield saturated products. The results obtained have shown that non-porous carbon material with no internal porosity and very low specific surface area, i.e. carbon felt, mostly yields higher light olefins which could be attributed to the high desorption rate of light olefins intermediates on one side, and the lower aromatics formation which lower the hydrogen for hydrogenation of such intermediates. On the other hand, porous carbon which could induce higher residence time, leads to the formation of higher liquid fraction and lower light olefins fraction within the gaseous products.

### Example 3: Comparison Between Plastic-to-Olefin Process of HDPE Using Rolled Carbon Felt or Metal Chips

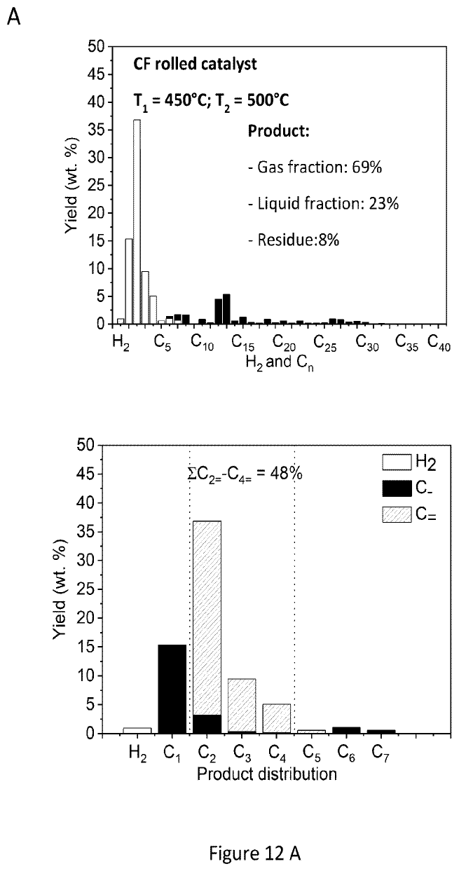

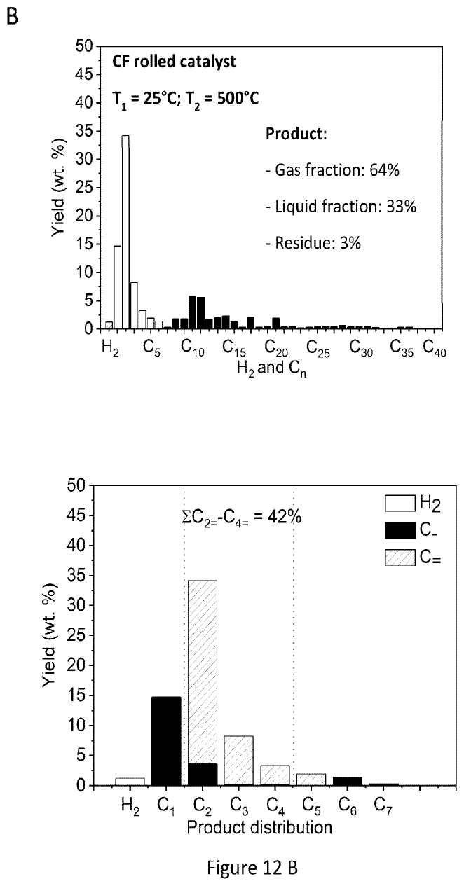

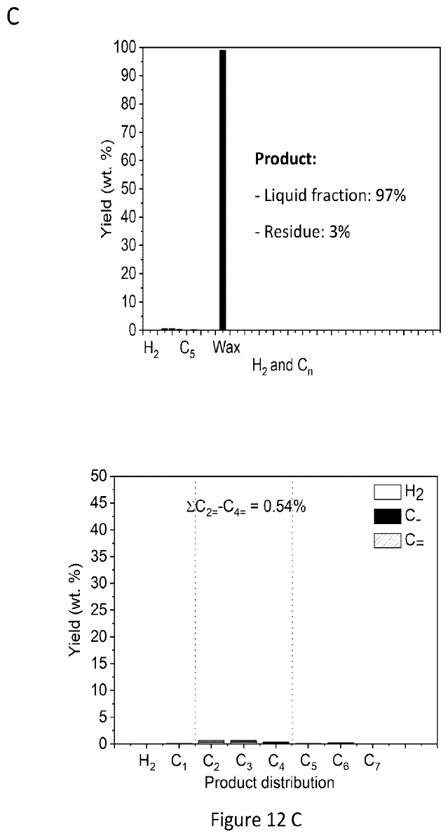

A first experiment (comparative) is conducted with metal chips made of an alloy of Fe and Ni in the form of metal springs with the following dimension: length 50 mm, diameter 4 mm, which are heated inductively to 500° C., and then polymer extrudates are dropped directly into the reaction zone. Results are shown in FIG. 12C.

A second experiment (inventive) is conducted under the same conditions with rolled carbon felt (CF) as free-metal carbon material. Results are shown in FIG. 12 B.

T₁ refers to flow temperature before the reactor inlet, and T₂ refers to conversion reaction (or cracking”) temperature. For both experiments, T₁=25° C. and T₂=500° C.

Reaction conditions: M=1.7 g for CF (H=40 mm) and 4 g for metal (H=35 mm); M_{HDPE}=20 g; F_{AR}=30 mL·min⁻¹; Feedstock for CF and metal chips falls directly onto the catalyst=5 g_{HDPE}·h⁻¹

The results of conversion are shown in FIG. 12 C.

In both experiments, gas fraction represents 64%, liquid fraction represents 33% and residue represents 3%. However, the experiment using metal chips converts polymer extrudates into wax at about 99.46 wt. % and into C₂-C₄ olefins at about 0.54 wt. %, whereas the experiment using rolled CF converts polymer extrudates into C₂-C₄ olefin at about 42 wt. %.

These results indicate that the induction-heated PTO process with metal catalyst does not allow obtaining C₂-C₄ olefins, contrary to the metal-free carbon material used in the process of the invention.

### Example 4: Comparison Between Plastic-to-Olefin Process of HDPE Using Rolled Carbon Felt in a One Step or Two Steps

Two experiments are conducted using rolled CF: a conversion reaction in one step (i.e., directly the cracking step) or a conversion reaction in two steps (i.e., a first stage of pre-cracking and then a step of cracking using metal-free carbon material).

T₁ refers to flow temperature or first stage temperature if present, and T₂ refers to conversion reaction (or “cracking”) temperature. For the one step process, T₁=25° C. and T₂=500° C. For the two steps process, T₁=450° C. and T₂=500° C.

Reaction conditions: M=1.7 g of rolled CF (H=40 mm); M_{HDPE}=20 g; T_{HDPE}=450° C. (JH); F_{AR}=30 mL·min 1. Feedstock for CF catalyst with 2 steps: 1^{st} step: pyrolysis by Joule heating (“JH”) and 2^{nd} step catalysis=10 g_{HDPE}·h⁻¹. Feedstock for CF falls directly onto the catalyst=5 g_{HDPE}·h⁻¹.

Results are shown on FIG. 12B for the one-step process, and on FIG. 12A for the two-step process.

For the one stage process, gas fraction represents 64 wt. %, liquid fraction represents 33 wt. % and residue represents 3 wt. %. For the two steps process, gas fraction represents 69 wt. %, liquid fraction represents 23 wt. % and residue represents 8 wt. %. The one step process converts polymer extrudates into C₂-C₄ olefin(s) at about 42 wt. %, whereas the two steps process converts polymer extrudates into C₂-C₄ olefin at about 48 wt. %.

These results indicate that the presence of the first stage improves the conversion rate to C₂-C₄ olefins, which is advantageous.

### REFERENCE LIST

1. Onwudili J. A., Muhammad C., Williams P. T. Influence of catalyst bed temperature and properties of zeolite catalysts on pyrolysis-catalysis of a simulated mixed plastics sample for the production of upgraded fuels and chemicals. J. Energ. Inst. 92, 1337-1347 (2019).
2. Lopez G., Artetxe M., Amutio M., Bilbao J., Olazar M. A review on thermal and catalytic pyrolysis of plastic solid waste (PSW). Thermochemical routes for the valorization of waste polyolefinic plastics to produce fuels and chemicals. A review. Renewable Sustainable Energy Rev. 73, 346-368 (2017).
3. Dogu O., Pelucchi M., Van de Vijver R., Van Steenberge P. H. M., D'hooge D. R., Cuoci A., Mehl M., Frassoldati A., Faravelli T., Van Geem K. M. The chemistry of chemical recycling of solid plastic waste via pyrolysis and gasification: state-of-the-art, challenges, and future directions. Prog. Energy Combust. Sci. 84, 100901 (2021).
4. J.-P. Lange, Managing Plastic Waste-Sorting, Recycling, Disposal, and Product Redesign, ACS Sustain. Chem. Eng., 2021, 9, 15722-15738 https://doi.org/10.1021/acssuschemeng.1c05013.
5. Layritz, L. S., Dolganova, I., Finkbeiner, M., Luderer, G., Penteado, A. T., Ueckerdt, F., et al. (2021). The Potential of Direct Steam Cracker Electrification and Carbon Capture & Utilization via Oxidative Coupling of Methane as Decarbonization Strategies for Ethylene Production. Appl. Energ. 296, 117049. doi: 10.1016/j.apenergy.2021.117049.
6. Schiffer Z. J., Manthiram K. Electrification and Decarbonization of the Chemical Industry. Joule 1, 10-14 (2017).
7. Jie X., Li W., Slocombe D., Gao Y., Banerjee I., Gonzalez-Cortes S., Yao B., Almegren H., Alshihri S., Dilworth J., Thomas J., Xiao T., Edwards P. Microwave-initiated catalytic deconstruction of plastic waste into hydrogen and high-value carbons. Nat. Catal. 3, 902-912 (2020).
8. Zhou N., Dai L., Lv Y., LI H., Deng W., Guo F., Chen P., Lei H., Ruan R. Catalytic pyrolysis of plastic wastes in a continuous microwave assisted pyrolysis system for fuel production. Chem. Eng. J. 418, 129412 (2021).
9. Wang, W., Tuci, G., Duong-Viet, C., Liu, Y., Rossin, A., Luconi, L., Nhut, J.-M., Nguyen-Dinh, L., Giambastiani, G., Pham-Huu, C., 2019. Induction heating: an enabling technology for the heat management in catalytic processes, ACS Catal., 2019, 9, 7921-7935. Khattak et al., 2019
10. Haneishi N., Tsubaki S., Abe E., Maitani M. M., Suzuki E., Fuji S., Fukushima J., Takizawa H., Wada Y., 2019. Enhancement of fixed-bed flow reactions under microwave irradiation by local heating at the vicinal contact points of catalyst particles. Sci. Rep. 9, 222.
11. Xie W., Yang F., Meng S., Scarpa F., Wang L. 2020. Perforation of needle-punched carbon-carbon composites during high-temperature and high-velocity ballistic impacts. Composite Structures 245, 112224 (2020).
12. Ali S., Garforth A. A., Harris D. H., Rawlence D. J., Uemichi Y. Polymer waste recycling over “used” catalysts. Catal. Today 75, 247-255 (2002).
13. De La Puente G., Klocker C., Sedran U. Conversion of waste plastics into fuels recycling polyethylene in FCC. Appl. Catal. B Environ. 36, 279-285 (2002).
14. Lin Y., Yang M. Catalytic conversion of commingled polymer waste into chemicals and fuels over spent FCC commercial catalyst in fluidised-bed reactor. Appl. Catal. B Environ. 69, 145-153 (2007).
15. Olazar M., Lopez G., Amutio M., Elordi G., Aguado R., Bilbao J. Influence of FCC catalyst steaming on HDPE pyrolysis product distribution. J. Anal. Appl. Pyrol. 85, 359-365 (2009).
16. Elordi G., Olazar M., Castano P., Artextxe M., Bilbao J. Polyethylene cracking on a spent FCC catalyst in a conical spouted bed. Ind. Eng. Chem. Res. 51, 14008-14017 (2012).
17. Eschenbacher A., Varghese R. J., Abbas-Abadi M. S., Van Geem K. M. Maximizing light olefins and aromatics as high value base chemicals via single step catalytic conversion of plastic waste. Chem. Eng. J. 428, 132087 (2022).
18. Moncada Quintero et al.: “Investigating mass transfer coefficients in lean methane combustion reaction through the morphological and geometric analysis of structured open cell foam catalysts”, Chemical Engineering Science Volume 281, 5 Nov. 2023, 119138.

1. Method of using a metal-free carbon material for converting plastic into C₂-C₄ olefins and/or other hydrocarbons, under direct induction heating at temperature less than or equal to 800° C.

2. Method according to claim 1, wherein the temperature is strictly less than 600° C.

3. Method according to claim 1, wherein said metal-free carbon material has a BET surface area of at least 0.10 m²/g and up to 2000 m²/g, as determined by ASTM-D-3663 (2020).

4. Method according to claim 1, wherein the carbon of said metal-free carbon material is selected from the group comprising graphite, graphene, mesoporous carbon, carbon black, acetylene black, pyrolytic carbon, activated carbon and any combinations thereof.

5. Method according to claim 1, wherein said metal-free carbon material has a morphology chosen among grain, felt, for example rolled felt, fiber, for example nanofiber, filament, 2D or 3D fabrics, foam as open cell foam, 3D-printed structures, sphere, cloth, monolith as honeycombs, extrudates, rod-shaped, sticks and particles, tube, for example nanotube, ring or trilobes, tablets, nanotablets and any combinations thereof.

6. Method according to claim 1, wherein said metal-free carbon material is supported by a non-carbon structure.

7. Method for converting plastic into C₂-C₄ olefin and/or other hydrocarbons, comprising:
optionally, a step of pre-cracking the plastic, and
a step of reaction under direct induction heating, with a metal-free carbon material as defined in claim 1, at temperature less than or equal to 800° C.

8. Method according to claim 7, wherein when it is present, the step of pre-cracking is carried out at a temperature comprised between 300° C. and 600° C.

9. Method according to claim 7, wherein when it is present, the pre-cracking step is carried out under induction heating, Joule heating or microwave heating.

10. Method according to claim 7, wherein when it is present, the pre-cracking step is carried out on silicon carbide, metal beads or any heat conductor materials, mixed with the plastic.

11. Method according to claim 7, wherein during the step of pre-cracking, the plastic is pre-cracked in a first-stage reactor, while vapors and/or liquids generated in the first section are swept with a gas flow toward the material in a second-stage reactor where the cracking process takes place.

12. Method according to claim 1, wherein said plastic is at least one plastic selected among high and low-density polyethylene, polypropylene, polystyrene, mixed industrial waste plastic, as low-density polyethylene, PET, PVC and polystyrene containing solid residue, plastics containing solid residue, C₁₅-C₄₅ waxes and polymers distilled at temperatures between 20° and 500° C.

13. Method according to claim 1, wherein said metal-free carbon material used in the reaction step is not mixed with the plastic material to be converted.

14. Method of process according to claim 13, wherein said metal-free carbon material is arranged in a packed bed.

15. Method according to claim 1, wherein said C₂-C₄ olefins are at least one chosen among ethylene, propylene and butylene and diolefins made from ethylene, propylene and butylene, and said other hydrocarbons are C₅₊ liquid hydrocarbons and/or paraffinic gaseous C₁ to C₄ hydrocarbons.

16. Method according to claim 1, wherein said C₅₊ liquid hydrocarbon is fuel oil.
